(19) United States
(12) Patent Application Publication
(10) Pub. No.: US 2026/0201213 A1
(43) Pub. Date: Jul. 16, 2026

(54) COMPOSITION INCLUDING PARTICLES AND TWO LIQUID PHASES AND RELATED PROCESS

(71) Applicant: 3M INNOVATIVE PROPERTIES COMPANY, St. Paul, MN (US)

(72) Inventors: Anna Pia P. Kröger, Neuss (DE); Karoline Anna Ostrowski, Duesseldorf (DE); Tom Gaide, Köln (DE); Kai U. Claussen, Duesseldorf (DE); Kerstin Unverhau, Neuss (DE); Hans Peter Dette, Neuss (DE); Frank Kuester, Duesseldorf (DE); Silke D. Mechernich, Düsseldorf (DE); Peter J. Schneider, Neuss (DE); Patricia J. Tegeder, Düsseldorf (DE); Jens Eichler, Kaarst (DE)

(21) Appl. No.: 19/136,456

(22) PCT Filed: Dec. 6, 2023
(86) PCT No.: PCT/IB2023/062329

§ 371 Date: Jun. 6, 2025

Related U.S. Application Data
(60) Provisional application No. 63/430,567, filed on Dec. 6, 2022.

(51) Int. Cl. C09J 7/38; C09J 11/04

(52) U.S. Cl. CPC C09J 7/385; C09J 11/04; C09J 2301/302; C09J 2301/414; C09J 2301/416

(57) ABSTRACT

A curable composition includes 25 to 70 volume percent particles, 25 to 74.8 volume percent of a primary liquid phase, and 0.15 to 20 volume percent of a secondary liquid phase, based on the total volume of the curable composition. The primary liquid phase includes a first monomer containing at least one of n-butyl acrylate, an alkyl acrylate monomer, or an alkyl methacrylate monomer, wherein alkyl is linear or branched and has at least five carbon atoms. The secondary liquid phase and the primary liquid phase form separate phases after mixing within a temperature range of from −20° C. to 30° C., and the particles are insoluble in the primary liquid phase and in the secondary liquid phase within a temperature range of from −20° C. to 30° C. A pressure-sensitive adhesive precursor capillary suspension, a pressure-sensitive adhesive made from a capillary suspension, and a process for making a pressure-sensitive adhesive are also described.

### BACKGROUND

Adhesives have been used for a variety of marking, holding, protecting, sealing, and masking purposes. Pressure-sensitive adhesives are useful for many applications. Pressure-sensitive adhesives (PSAs) are well known to one of ordinary skill in the art to possess certain properties including the following: (1) aggressive and permanent tack, (2) adherence with no more than finger pressure, (3) sufficient ability to hold onto an adhered, and (4) sufficient cohesive strength. As applications for pressure-sensitive adhesives have increased substantially in recent years, performance requirements have become increasingly demanding. Materials that have been found to function well as pressure-sensitive adhesives are polymers designed and formulated to exhibit the requisite viscoelastic properties resulting in a desired balance of tack, peel adhesion, and shear strength. The most commonly used polymers for pressure-sensitive adhesives are various (meth)acrylate-based polymers, natural rubber, synthetic rubbers, and silicones.

U.S. Pat. Appl. Pub. Nos. 2016/0083628 (Heimink et al.) and 2011/0129661 (Tsubaki et al.) describe pressure-sensitive adhesives including hollow glass microspheres.

### SUMMARY

The present disclosure provides a curable composition useful, for example, as a pressure-sensitive adhesive precursor. The curable composition can become a pressure-sensitive adhesive after curing. Typically, and advantageously, the curable composition has little to no flow, which allows it to be dispensed in a desired shape and hold that shape upon curing and for as much time is needed before curing. Thus, the curable composition allows for great flexibility in the shape of the pressure-sensitive adhesive and the construction of bonded articles from the pressure-sensitive adhesive.

In one aspect, the present disclosure provides a curable composition including particles in an amount from 25 volume percent to 70 volume percent, based on the total volume of the curable composition, a primary liquid phase in an amount from 25 volume percent to 74.8 volume percent, based on the total volume of the curable composition, and a secondary liquid phase in an amount from 0.15 volume percent to 20 volume percent, based on the total volume of the curable composition. The primary liquid phase includes a first monomer containing at least one of n-butyl acrylate, an alkyl acrylate monomer, or an alkyl methacrylate monomer, wherein alkyl is linear or branched and has at least five carbon atoms. The secondary liquid phase and the primary liquid phase form separate phases after mixing within a temperature range of from −20° C. to 30° C., and the particles are insoluble in the primary liquid phase and in the secondary liquid phase within a temperature range of from −20° C. to 30° C. In some embodiments, the curable composition is a capillary suspension.

In another aspect, the present disclosure provides a pressure-sensitive adhesive precursor capillary suspension. This can also be understood as a pressure-sensitive adhesive precursor composition in the form of a capillary suspension and a capillary suspension comprising a pressure-sensitive adhesive precursor composition.

In another aspect, the present disclosure provides a pressure-sensitive adhesive made from a capillary suspension.

In another aspect, the present disclosure provides a process for making a pressure sensitive adhesive. The process includes curing the curable composition to make the pressure-sensitive adhesive.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5).

As used herein, the terms “primary liquid phase” and “secondary liquid phase” describe the respective phases in their liquid form. That means that the description of their properties relates to temperatures above their melting point. For example, the description of the particles being insoluble in the primary liquid phase “at a temperature of 30° C. and below” defines a temperature range of higher than the melting point of the primary liquid phase and 30° C. Accordingly, the description of the particles being insoluble in the secondary liquid phase “at a temperature of 30° C. and below” defines a temperature range of higher than the melting point of the secondary liquid phase and 30° C. Accordingly, the description of the primary liquid phase and the secondary liquid phase forming separate phases upon mixing “at a temperature of 30° C. and below” defines a temperature range of higher than the melting point of both, the primary liquid phase and the secondary liquid phase, and 30° C.

The terms “first” and “second” are used in this disclosure in their relative sense only. It will be understood that, unless otherwise noted, those terms are used merely as a matter of convenience in the description of one or more of the embodiments.

The term “acrylic” refers to both acrylic and methacrylic polymers, oligomers, and monomers.

The term “(meth)acrylate” with respect to a monomer, oligomer, or polymer means a vinyl-functional alkyl ester formed as the reaction product of an alcohol with an acrylic or a methacrylic acid. “(Meth)acrylate” includes, separately and collectively, methacrylate and acrylate.

“Alkyl group” and the prefix “alk-” are inclusive of both straight chain and branched chain groups having up to 30 carbons (in some embodiments, up to 20, 15, 12, 10, 8, 7, 6, or 5 carbons) unless otherwise specified. The term “alkyl” refers to a monovalent group which is a saturated hydrocarbon. It is understood that hydrocarbons include only carbon-carbon and carbon-hydrogen bonds.

“Alkylene” is the multivalent (e.g., divalent or trivalent) form of the “alkyl” groups defined above.

“Arylalkylene” refers to an “alkylene” moiety to which an aryl group is attached.

“Aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups, examples of which include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

A “monomer unit” of a polymer or oligomer is a segment of a polymer or oligomer derived from a single monomer.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked.

The terms “curable”, “curing”, and “cured” refer to making polymer chains made from one or more monomers.

The term “ceramic” refers to glasses, crystalline ceramics, glass-ceramics, and combinations thereof.

3D printing, also known as “additive manufacturing”, refers to a process to create a three-dimensional object by sequential deposition of materials in defined areas, typically by generating successive layers of material. The object is typically produced under computer control from a 3D model or other electronic data source by an additive printing device typically referred to as a 3D printer.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1 is photograph of Example 4 after dispensing; and

FIG. 2 is photograph of Example 4 after dispensing and curing.

### DETAILED DESCRIPTION

The curable composition of the present disclosure, which may be a capillary suspension, comprises particles in an amount from 25 volume percent (vol. %) to 70 vol. %, based on the total volume of the curable composition, a primary liquid phase in an amount from 25 vol. % to 74.8 vol. %, based on the total volume of the curable composition, and a secondary liquid phase in an amount from 0.15 vol. % to 20 vol. %, based on the total volume of the curable composition. It should be understood that the total volume percent of the curable composition cannot be above 100 percent. Thus, when the curable composition comprises greater than 55 vol. % particles, it must comprise less than 20 vol. % secondary liquid phase. In some embodiments, the curable composition comprises from 25 vol. % to 65 vol. %, 25 vol. % to 60 vol. %, 35 vol. % to 60 vol. %, or 35 vol. % to 55 vol. % of the particles, based on the total volume of the curable composition. In some embodiments, the curable composition comprises the primary liquid phase in an amount from 30 vol. % to 74.8 vol. %, 35 vol. % to 74.8 vol. %, 40 vol. % to 70 vol. %, or 38 vol. % to 65 vol. % based on the total volume of the curable composition. In some embodiments, the curable composition comprises the secondary liquid phase in an amount from 0.2 vol. % to 20 vol. %, 0.5 vol. % to 20 vol. %, from 0.4 vol. % to 10 vol. %, from 0.4 vol. % to 5 vol. %, or from 0.4 vol. % to 2 vol. %, based on the total volume of the composition. In some embodiments, the curable composition comprises particles in an amount from 35 vol. % to 60 vol. %, based on the total volume of the composition; a primary liquid phase in an amount from 38 vol. % to 64.6 vol. %, based on the total volume of the composition, and a secondary liquid phase in an amount from 0.4 volume percent to 2 volume percent, based on the total volume of the composition. In some embodiments, the particles, the primary liquid phase, and the secondary liquid phase account for at least 90, 95, 96, 97, 98, or 99 vol. % and up to 100 vol. % of the composition.

In some embodiments, the particles are hollow particles (e.g., hollow ceramic microspheres or hollow polymeric microspheres), and the particles are present in an amount from 5 weight percent (wt. %) to 30 wt. %, 10 wt. % to 25 wt. %, or 10 wt. % to 20 wt. %, the primary liquid phase is present in an amount from 45 wt. % to 94.5 wt. %, 50 wt. % to 89.5 wt. %, or 60 wt. % to 85 wt. %, and the secondary liquid phase is present in an amount from 0.5 wt. % to 35 wt. %, 0.5 wt. % to 20 wt. %, or 0.5 wt. % to 5 wt. %, based on the total weight of the curable composition. Hollow particles typically have a density less than the primary liquid phase and the secondary liquid phase.

A variety of particles are useful in the curable composition of the present disclosure, which may be a capillary suspension. Examples of suitable particles include inorganic filler particles, hollow particles, porous particles, ceramic particles, hollow ceramic particles, polymeric particles, hollow polymer particles, surface-modified particles, metal particles, hollow metal particles, carbon nanotubes, polymer composite particles, coated particles, coated hollow particles, and combinations thereof. Suitable particles may have various particle sizes, particle shapes, particle size distributions, and particle aspect ratios. The particles may have regular or irregular shapes and may be generally spherical, rod-shaped, or plate-shaped. Suitable inorganic fillers include metal oxides, metal carbides, metal nitrides, metal carbides, and metal phosphates. Suitable ceramics include barium titanate, aluminum oxide, boron nitride, zirconia oxide, silicon nitride, silicon carbide. Suitable polymeric particles include polyvinylidene fluoride, polytetrafluoroethylene, ethylene-tetrafluoroethylene, perfluoroalkoxy alkanes, fluoroelastomers, perfluoroelastomers, polyethylene, polypropylene, polyamide 12, polyamide 11, polyether ether ketone, poly ether ketone, and poly ether ketone ketone. Suitable metal particles include silver, iron, steel, copper, nickel, and titanium.

The particles may be, for example, electrically conductive particles, thermally conductive particles, electrically insulating particles, thermally insulating particles, light weight particles, flame retardant particles, toughening particles, water absorption particles, water repellent particles, piezo electric particles, magnetic particles, dielectric particles, and any combination thereof. These properties may be provided by the particle itself or by a coating on a particle of a different composition. For example, a non-conductive particle can be coated with an electrically conductive coating and/or thermally conductive coating. Suitable electrically conductive particles include metal particles and carbon black particles. Suitable thermally conductive particles include boron nitride particles, graphite particles, aluminum oxide particles, zinc oxide particles, aluminum nitride particles, silver particles, and ceramic microspheres. Suitable electrically insulating particles include boron nitride particles, talc particles, and amorphous silica coated particles. Suitable thermally insulating particles include hollow ceramic microspheres (e.g., glass bubbles). Suitable flame retardant particles include alumina trihydrate, magnesium hydroxide, huntite, and hydromagnesite. Suitable water-absorbing particles include sodium polyacrylate, copolymers of polyacrylamide, ethylene maleic anhydride, and polyvinyl alcohol. Suitable water repellent particles include any of the fluropolymers described above. Suitable piezo electric particles include polyvinylidene fluoride, polyamides, poyvinylidene chloride, lead zirconate titanate, lead titanate, quartz, potassium niobate, and barium titanate. Suitable magnetic particles include iron, nickel, cobalt, and neodymium-iron-boron. Suitable dielectric particles include polyvinylidene fluoride, polyethylenylene, polytetrafluoroethylene, ceramics, steatit, aluminum oxide, mica, air-filled particles, barium titanate, titanium oxide, strontium titanate, and zirconium oxide. Any of these particles may be hollow or solid. In some embodiments, the particles comprise at least one of ceramic microspheres, polymeric microspheres, metallic particles, electrically conductive particles, or thermally conductive particles, any of which may be hollow or solid. In some embodiments, the particles are not electrically conductive. In some embodiments, the particles are not thermally conductive. Particles can be obtained from a variety of commercial sources. For example, aluminum oxide particles can be obtained from Bestry Perfomance Materials, Shagnhai, China, under the trade designation “BAK”.

Hollow particles may be useful, for example, for light-weighting. Examples of suitable hollow particles include hollow ceramic microspheres (i.e., glass bubbles), hollow inorganic beads, hollow inorganic particles or nanoparticles, hollow silica particles or nanoparticles, hollow carbide particles (e.g. silicon carbide particles, boron carbide particles), hollow nitride particles (e.g. carbon nitride particles, aluminum nitride particles, silicon nitride particles, boron nitride particles), hollow polymeric particles, hollow aluminum balloons, and combinations thereof. In some embodiments, the particles comprise at least one of hollow ceramic microspheres or hollow polymeric particles. In some embodiments, the particles comprise hollow glass microspheres.

Useful hollow glass microspheres include those marketed by 3M Company under the trade designation “3M GLASS BUBBLES” (e.g., grades K1, K15, S15, S22, K20, K25, S32, K37, S38, S38HS, S38×HS, K46, A16/500, A20/1000, D32/4500, H50/10000, S60, S60HS, and iM30K); glass bubbles marketed by Potters Industries, Valley Forge, PA, (an affiliate of PQ Corporation) under the trade designations “Q-CEL HOLLOW SPHERES” (e.g., grades 30, 6014, 6019, 6028, 6036, 6042, 6048, 5019, 5023, and 5028) and “SPHERICEL HOLLOW GLASS SPHERES” (e.g., grades 110P8 and 60P18); and hollow glass particles marketed by Silbrico Corp., Hodgkins, IL under the trade designation “SIL-CELL” (e.g., grades SIL 35/34, SIL-32, SIL-42, and SIL-43). Useful hollow ceramic microspheres further include aluminosilicate microspheres extracted from pulverized fuel ash collected from coal-fired power stations (i.e., cenospheres). Useful cenospheres include those marketed by Sphere One, Inc., Chattanooga, TN, under the trade designation “EXTENDOSPHERES HOLLOW SPHERES” (e.g., grades XOL-200, XOL-150, SG, MG, CG, TG, HA, SLG, SL-150, 300/600, 350 and FM-1); and those marketed by 3M Company under the trade designation “3M HOLLOW CERAMIC MICROSPHERES” (e.g., grades G-3125, G-3150, and G-3500). Useful hollow ceramic microspheres further include perlite microspheres, such as those available, for example, from Silbrico Corporation, Hodgkins, IL. Useful hollow polymer particles include elastomeric particles available, for example, from Akzo Nobel, Amsterdam, The Netherlands, under the trade designation “EXPANCEL”.

Useful hollow ceramic microspheres (e.g., glass bubbles) have an average true density in a range from 0.1 g/cm³ to 1.2 g/cm³, from 0.1 g/cm³ to 1.0 g/cm³, from 0.1 g/cm³ to 0.8 g/cm³, from 0.1 g/cm³ to 0.5 g/cm³, or, in some embodiments, 0.1 g/cm³ to 0.3 g/cm³. The term “average true density” is the quotient obtained by dividing the mass of a sample of glass bubbles by the true volume of that mass of glass bubbles as measured by a gas pycnometer. The “true volume” is the aggregate total volume of the glass bubbles, not the bulk volume. For the purposes of this disclosure, average true density is measured using a pycnometer according to ASTM D2840-69, “Average True Particle Density of Hollow Microspheres”. The pycnometer may be obtained, for example, under the trade designation “Accupyc 1330 Pycnometer” from Micromeritics, Norcross, Georgia. Average true density can typically be measured with an accuracy of 0.001 g/cc. Accordingly, each of the density values provided above can be #one percent.

The median particle size of the particles useful for practicing the present disclosure may be, for example, in a range from 0.1 micrometer (μm) to 250 μm (in some embodiments from 5 μm to 250 μm, from 5 μm to 150 μm, from 10 μm to 120 μm, from 20 μm to 100 μm, or from 50 μm to 100 μm. The particles may have a multimodal (e.g., bimodal or trimodal) size distribution (e.g., to improve packing efficiency) as described, for example, in U.S. Pat. Appl. Publ. No. 2002/0106501 A 1 (Debe). As used herein, the term size identifies the largest dimension of the particle is considered to be equivalent with the diameter and height of a microsphere. For the purposes of the present disclosure, the median size (D50) by volume is determined by laser light diffraction by dispersing the glass bubbles in deaerated deionized water. Laser light diffraction particle size analyzers are available, for example, under the trade designation “SATURN DIGISIZER” from Micromeritics. When the curable composition is a capillary suspension, it may be useful for the particle size of the particles to be larger than the droplet size of the secondary liquid in the capillary suspension. The droplet size can be determined by light microscopy.

It can be useful, for example, for at least a first portion of the conductive filler to have a median (i.e., D50) particle size of at least 20 micrometers, in a range from 20 to 100 micrometers or 50 to 90 micrometers. Furthermore, at least a second portion of the conductive filler can have a median particle size in a range from 5 to 20 micrometers or 5 to 15 micrometers. It also may be useful to have a third portion of the conductive filler to have a median particle size of up to 5 micrometers, in some embodiments, in a range from 0.1 to 5 micrometers, 0.5 to 5 micrometers, or 0.5 to 2.5 micrometers. Including conductive fillers having multiple particle size distributions can be useful for achieving a high loading of conductive filler in the composition.

Particles described above in any of their embodiments may be surface-modified or coated. Suitable coated particles include those having a metal coating or a metal oxide coating. Inorganic particles may be surface-modified to have organic groups on the surface. Organic groups can be polymerizable groups (e.g., amino-alkyl groups or (meth)acrylate groups) or non-polar groups (e.g., alkyl groups). Organic groups may be formed on an inorganic particle surface through covalent bonds, in some embodiments, siloxane bonds by reacting the inorganic particle with a silane, for example, containing at least one hydrolysable functional group and at least one non-hydrolysable functional group. Suitable silanes of this type include alkoxy silanes, for example, represented by formula:

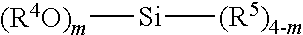

wherein each R⁴ is independently an alkyl group having 1 to 6 (in some embodiments, 1 to 4 or 1 or 2 carbon atoms); m is 1 to 3 (in some embodiments 2 or 3 or 3); and each R⁵ is independently alkyl having from 1 to 30 carbon atoms, (in some embodiments, from 1 to 25, 4 to 22, 4 to 18, or 8 to 18 carbon atoms). Hydrophobic coatings can also be applied to particles using an emulsion, suspension or solution of a hydrocarbon wax, polyethylene wax, fluorinated hydrocarbon wax, silicone, or a combination thereof.

A useful method for treating particles with a compound of formula (R⁴O)ₘ—Si—(R⁵)₄₋ₘ includes combining the compound with the particles in a medium comprising water. Hydrolysis of the hydrolyzable groups in a compound of formula (R⁴O)ₘ—Si—(R⁵)₄₋ₘ typically generates silanol groups, which participate in condensation reactions to form siloxanes and/or participate in bonding interactions with silanol groups on siliceous fillers. Hydrolysis can occur, for example, in the presence of water optionally in the presence of an acid or base. The water necessary for hydrolysis is typically added to a composition containing the compound of (R⁴O)ₘ—Si—(R⁵)₄₋ₘ and the particles, although, in some cases, the water may be adsorbed to the surface of the filler, or may be present in the atmosphere to which the filler is exposed (e.g., an atmosphere having a relative humidity of at least 10%, 20%, 30%, 40%, or even at least 50%). In some embodiments, it is useful to surface particles at elevated temperatures under acidic or basic conditions for approximately one to 24 hours. The particles may then be separated from the liquid phase and dried. Further methods for making a hollow, non-porous particle having a hydrophobic coating or surface-modification are described, for example, in U.S. Pat. Appl. Pub. No. 2016/0083628 (Heimink et al.).

The primary liquid phase in the curable composition of the present disclosure, which may be a capillary suspension, comprises a first monomer comprising at least one of n-butyl acrylate, an alkyl acrylate monomer, or alkyl methacrylate monomer, wherein alkyl is linear or branched and has at least five carbon atoms. Examples of suitable alkyl (meth)acrylate monomers include those represented by formula I:

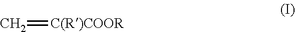

In formula I, R is linear or branched and has 4 to 32 carbon atoms. In some embodiments, the alkyl group contains 4 to 25, 6 to 20, 6 to 18, 6 to 16, 6 to 12, or 8 to 12 carbon atoms. Examples of alkyl groups include n-butyl, n-pentyl, n-hexyl, cyclohexyl, n-heptyl, n-octyl, 2-ethylhexyl, 2-octyl and 2-propylheptyl. In formula I, R′ is hydrogen or a methyl group, in some embodiments, hydrogen.

In some embodiments, the first monomer comprises at least one of n-butyl acrylate, hexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, 2-propylheptyl acrylate, n-decyl acrylate, isodecyl acrylate, n-dodecyl acrylate, myristyl acrylate, isomyristyl acrylate, n-tridecyl acrylate, n-tetradecyl acrylate, stearyl acrylate, isostearyl acrylate, 17-methyl-1-heptadecyl acrylate, 2-methylbutyl acrylate, 4-methyl-2-pentyl acrylate, and a methacrylates of any of the foregoing acrylates except n-butyl acrylate. In some embodiments, the first monomer comprises at least one of isooctyl acrylate, 2-ethylhexyl acrylate, 2-propylheptyl acrylate, 2-octyl acrylate, a methacrylate of the foregoing acrylates, or butyl acrylate. In some embodiments, the first monomer comprises at least one of isooctyl acrylate, 2-ethylhexyl acrylate, 2-octyl acrylate, or 2-propylheptyl acrylate, 2-Octyl may be prepared by conventional techniques and/or may be derived from biological material, meaning that at least a part (for example, at least 50 weight percent) of its chemical structure comes from biological materials. In some embodiments, the first monomer comprises at least one of isooctyl acrylate or 2-ethylhexyl acrylate.

Suitable first monomers further include mixtures of at least two or at least three structural isomers of a secondary alkyl (meth)acrylate of formula II:

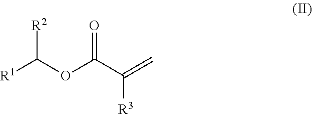

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, 7, or 11. Methods for making and using such monomers and monomer mixtures are described in U.S. Pat. No. 9,102,774 (Clapper et al.). Mixtures of one or more monomers of formula I, formula II, or combinations of formulas I and II may be useful for the first monomer. In some embodiments, the at least one of an alkyl acrylate monomer or alkyl methacrylate monomer comprises at least one acrylate (as opposed to methacrylate).

Acrylic-based polymeric materials included in known pressure-sensitive adhesives are often prepared from one or more non-polar (meth)acrylate monomers (e.g., any of the first monomers described above) having a relatively low glass transition temperature (Tg) (i.e., the Tg of a monomer is measured as a homopolymer prepared from the monomer) plus various optional monomers. The terms “glass transition temperature” and “Tg” are used interchangeably and refer to the glass transition temperature of a material or a mixture.

In some embodiments of the curable composition of the present disclosure, which may be a capillary suspension, the primary liquid phase further comprises a second monomer. In some embodiments, the second monomer comprises a polar functional group and a polymerizable carbon-carbon double bond. Examples of polar functional groups include carboxylic acid groups, sulfonic acid groups, phosphonic acid groups, ketones, amides, amines, alcohols, ethers, and combinations thereof. The polymerizable group can be a (meth)acryloyl group or a vinyl group (i.e., CH₂═CH₂— group) that is not a (meth)acryloyl group. In some embodiments, the second monomer is a (meth)acrylate having a polar functional group. Examples of suitable monomers having polar functional groups include acrylic acids (e.g., acrylic acid, methacrylic acid, itaconic acid, maleic acid, fumaric acid, crotonic acid, citraconic acid, maleic acid, oleic acid, beta-carboxyethyl (meth)acrylate) and salts thereof, sulfonic acids (e.g., 2-sulfoethyl methacrylate, styrene sulfonic acid, 2-acrylamido-2-methylpropanesulfonic acid) and salts thereof, phosphonic acids (e.g., vinylphosphonic acid) and salts thereof, acrylamides (e.g., acrylamide, methacrylamide, N-ethyl acrylamide, N-hydroxyethyl acrylamide, 3-hydroxypropyl acrylamide, N-isopropyl acrylamide, N-tert-octyl acrylamide, N-octyl acrylamide, N-t-butyl acrylamide, N,N-dimethyl acrylamide, N,N-diethyl acrylamide, N,N-dipropyl acrylamide, N,N-dibutyl acrylamide, N-ethyl-N-dihydroxyethyl acrylamide, and methacrylamides of the foregoing acrylamides), hydroxyl- or amino-substituted acrylates (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, ethoxylated hydroxyethyl methacrylate such as monomers commercially available from Sartomer under the trade designations CD570, CD571, CD572, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl-2-pyrrolidone, N-vinyl caprolactam, cyanoethyl (meth)acrylate, acrylonitrile, maleic anhydride, and combinations thereof. Any suitable salt of an acidic group can be used. In many embodiments, the cation of the salt is an ion of an alkaline metal (e.g., sodium, potassium, or lithium ion), an ion of an alkaline earth metal (e.g., calcium, magnesium, or strontium ion), an ammonium ion, or an ammonium ion substituted with one or more alkyl or aryl groups. Still other suitable polar second monomers having an ethylenically unsaturated group include those with a single ethylenically unsaturated group and an ether group (i.e., a group containing at least one alkylene-oxy-alkylene group of formula —R—O—R— where each R is an alkylene having 1 to 4 carbon atoms). Examples of monomers including an ether group include alkoxylated alkyl (meth)acrylates such as ethoxyethoxyethyl acrylate, 2-methoxyethyl acrylate, and 2-ethoxyethyl acrylate; and poly(alkylene oxide) acrylates such as poly(ethylene oxide) acrylates and poly(propylene oxide) acrylates having an end group such as a hydroxyl group or an alkoxy group. In some embodiments, the second monomer comprises a heterocyclic group. Examples of suitable second monomers including cycloaliphatic groups include tetrahydrofurfuryl (meth)acrylate, N-vinyl-2-pyrrolidone, and N-vinyl caprolactam. The various monomers having a polar functional group may be useful, for example, for increasing adhesion of a resulting pressure-sensitive adhesive to a substrate or a backing layer, to enhance the cohesive strength of a resulting pressure-sensitive adhesive, or both.

Combinations of any of the polar monomers described above can be useful. A variety of suitable amounts of polar monomer can be useful to prepare a pressure-sensitive adhesive. In some embodiments, the polar monomer(s) are present in amounts up to 15 weight percent based on a total weight of polymerizable monomers. In some embodiments, the polar monomer(s) are present in amounts of at least 0.1 weight percent, at least 0.5 weight percent, at least 1 weight percent, or at least 2 weight percent, or even at least 3 weight percent, based on the total weight of polymerizable monomers. Accordingly, in some embodiments, the polar monomer is present in an amount in a range of from 0.1 to 15 weight percent, from 0.5 to 15 weight percent, from 1.0 to 10 weight percent, from 2.0 to 8.0 weight percent, from 2.5 to 6.0 weight percent, or from 3.0 to 6.0 weight percent, based on the total weight of the polymerizable monomers. In some embodiments, the amount of polar monomer is up to 10 weight percent or up to 5 weight percent. For example, the polar monomer can be present in an amount in a range 0.5 to 10 weight percent, 1 to 10 weight percent, 0 to 5 weight percent, 0.5 to 5 weight percent, or 1 to 5 weight percent based on a total weight of the polymerizable monomers.

In some embodiments, the second monomer comprises a second non-polar monomer having a polymerizable carbon-carbon double bond. In some embodiments, the second monomer comprises an alkyl group having less than four or up to four carbon atoms. Suitable second monomers include methyl (meth)acrylate, ethyl (meth)acrylate, n-propyl (meth)acrylate, isopropyl (meth)acrylate, n-butyl methacrylate, isobutyl (meth)acrylate, tert-butyl (meth)acrylate, vinyl acetate, vinyl pivalate, vinyl propionate, and vinyl valerate. In some embodiments, the second monomer comprises an aromatic group. Examples of suitable second monomers including aromatic groups include phenyl (meth)acrylate, benzyl (meth)acrylate, 2-biphenylhexyl (meth)acrylate, 2-phenoxy ethyl (meth)acrylate, vinyl benzoate, vinyl 4-tert-butylbenzoate, styrene and derivatives thereof such as alkyl-substituted styrene and other substituted stryenes (e.g., α-methyl styrene, 4-tert-butoxystyrene, 4-(tert-butyl) styrene, 4-chloromethylstyrene, chloromethylstyrene, 3-chlorostyrene, 2 (diethylamino)ethylstyrene, 2-methylstyrene, 4-methylstyrene, and 4-nitrostyrene), and combinations thereof. In some embodiments, the second monomer comprises a cycloalkyl group. Examples of suitable second monomers including cycloalkyl groups include isobornyl (meth)acrylate, cyclohexyl (meth)acrylate, isophoryl (meth)acrylate, cyclohexyl (meth)acrylate, and any combinations or mixtures thereof. In some embodiments, the second monomer comprises at least one of isobornyl (meth)acrylate, cyclohexyl (meth)acrylate, isophoryl (meth)acrylate, and combinations thereof. In some embodiments, the second monomer comprises isobornyl (meth)acrylate, in some embodiments, isobornyl acrylate.

In some embodiments, the second monomer (e.g., the second non-polar monomer) has a relatively high Tg when formed into a homopolymer (i.e., a polymer prepared using a single polymerizable material). When formed into a homopolymer, these monomers typically have a glass transition temperature (Tg) of at least 20° C., or at least 25° C., or at least 30° C., or at least 40° C., or even at least 50° C. Such second monomers may be advantageous for modulating the Tg of the polymerizable material and/or for providing enhanced adhesive strength in a resulting pressure-sensitive adhesive.

In some embodiments, the second monomer comprises a polymerizable carbon-carbon double bond and at least one of a polar functional group, a cycloaliphatic group, a heterocyclic group, an aromatic group, or an alkyl group having less than four carbon atoms. It should be understood that combinations of any of the second monomers described above can be used. For clarity, a combination of two or more second monomers may be referred to hereinbelow as a second monomer and further monomer(s), in which the further monomer may be any of the second monomers described above.

In some embodiments of the curable composition, which may be a capillary suspension, the first monomer is present in the primary liquid phase in an amount of at least 50 weight percent, based on the total weight of the primary liquid. In some embodiments, the primary liquid phase comprises from 50 to 99.5 weight percent or from 60 to 90 weight percent of the first monomer and from 0.5 to 50 weight percent, from 1.0 to 50 weight percent, from 3.0 to 40 weight percent, from 5.0 to 35 weight percent, or from 10 to 30 weight percent, of one or more second monomers described above, based on the total weight of the primary liquid phase. Typically, the first monomer is used in an amount of 75 weight percent to 100 weight percent based on a total weight of monomers to make an acrylic polymer, and one or more second monomer as described above is used in an amount of 0 weight percent to 25 weight percent based on a total weight of monomers to make an acrylic polymer. In some embodiments, the first monomer is used in an amount of at least 80, 85, 90, 92, 95, 97, 98, or 99 percent by weight based on the total weight of the monomers, and the one or more second monomers is used in an amount of up to 20, 15, 10, 8, 5, 3, 2, or 1 percent by weight based on the total weight of the monomers.

In some embodiments of the curable composition of the present disclosure, which may be a capillary suspension, the primary liquid phase further comprises a crosslinking monomer, having at least two polymerizable carbon-carbon double bonds. A crosslinking monomer can be useful, for example, for increasing the cohesive strength and the tensile strength of a resulting pressure-sensitive adhesive. Suitable crosslinking monomers can have more than 2, for example, at least 3 or 4, polymerizable carbon-carbon double bonds (in some embodiments, (meth)acryloyl groups). Examples of crosslinking monomers with multiple (meth)acryloyl groups are di(meth)acrylates, tri(meth)acrylates, and tetra(meth)acrylates, penta(meth)acrylates. Mixtures of crosslinking monomers may also be used.

Examples of suitable crosslinking monomers with two acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene diacrylate, neopentylglycol hydroxypivalate diacrylate modified caprolactone, and dimethacrylates of any of the foregoing diacrylates, and combinations thereof. Examples of crosslinking monomers with three or four (meth)acryloyl groups include trimethylolpropane triacrylate (e.g., commercially available under the trade designation TMPTA-N from Cytec Industries, Inc., Smyrna, GA and under the trade designation SR-351 from Sartomer, Exton, PA), pentaerythritol triacrylate (e.g., commercially available under the trade designation SR-444 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). Examples of suitable with five (meth)acryloyl groups includes dipentaerythritol pentaacrylate (e.g., commercially available under the trade designation SR-399 from Sartomer). Methacrylates of the foregoing acrylates and combinations thereof are also useful.

Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Examples of such crosslinkers include poly(alkylene oxides) with at least two acryloyl groups (e.g., polyethylene glycol diacrylates commercially available from Sartomer such as SR210, SR252, and SR603) and poly(urethanes) with at least two (meth)acryloyl groups (e.g., polyurethane diacrylates such as CN9018 from Sartomer). When present, the crosslinking monomer is present in the primary liquid in an amount not more than five, four, three, or two percent by weight, based on the total weight of the primary liquid. In some embodiments, the crosslinking monomer is present in an amount of 0.002 to 2 parts per hundred parts of the first and second monomers, for example from about 0.01 to about 0.5 parts or from about 0.05 to 0.15 parts per hundred parts of the first and second monomers.

Other types of crosslinkers can be used rather than those having at least two polymerizable carbon-carbon double bonds. The crosslinker can have multiple groups that react with functional groups such as acidic groups on second monomers. For example, monomers with multiple aziridinyl groups can be used that are reactive with carboxyl groups. For example, the crosslinker can be a bis-amide crosslinker as described in U.S. Pat. No. 6,777,079 (Zhou et al.). In still other methods of crosslinking, thermal crosslinkers may be used, optionally in combination with suitable accelerants and retardants. Suitable thermal crosslinkers for use herein include isocyanates, more particularly trimerized isocyanates and/or sterically hindered isocyanates that are free of blocking agents, and epoxide compounds such as epoxide-amine crosslinker systems. Advantageous crosslinker systems and methods are described, for example, in DE202009013255 U1, published Mar. 18, 2010, U.S. Pat. No. 5,877,261 (Harder et al.), 7,910,163 (Zollner et al.), 7,935,383 (Zollner et al.), 8,449,962 (Prenzel et al.), 8,802,777 (Zollner et al.), 10,457,791 (Czerwonatis et al.), 9,505,959 (Grittner et al.), and 9,896,605 (Zollner et al.), and U.S. Pat. Appl. Pub. No. 2011/0274843 (Grittner et al.). Suitable accelerants and retardant systems are described, for example, in U.S. Pat. No. 9,200,129 (Czerwonatis et al.). If present, a crosslinker can be used in any suitable amount. In many aspects, the crosslinker is present in an amount of up five, four, three, or two percent by weight, based on the total weight of the primary liquid. In some embodiments, the crosslinker is present in an amount in a range of 0 to 5 weight percent, 0.01 to 5 weight percent, 0.05 to 5 weight percent, 0 to 3 weight percent, 0.01 to 3 weight percent, 0.05 to 3 weight percent, 0 to 1 weight percent, 0.01 to 1 weight percent, or 0.05 to 1 weight percent, based on the total weight of the primary liquid phase.

Crosslinking may also be achieved in a pressure-sensitive adhesive using high energy electromagnetic radiation such as gamma or e-beam radiation.

In some embodiments, the curable composition, which may be a capillary suspension, further comprises a free-radical initiator. An initiator for free radical polymerization is typically added to the primary liquid phase. The polymerization initiator can be a thermal initiator, a photoinitiator, or both. Any suitable thermal initiator or photoinitiator known for free radical polymerization reactions can be used. The initiator is typically present in an amount in the range of 0.01 to 5 weight percent, in the range of 0.01 to 2 weight percent, in the range of 0.01 to 1 weight percent, or in the range of 0.01 to 0.5 weight percent based on a total weight of first and optionally second and crosslinking monomers.

In some embodiments, the free-radical initiator is a thermal initiator. Suitable initiators that can be soluble in the primary liquid phase include various azo compounds such as those commercially available under the trade designation VAZO from E. I. DuPont de Nemours Co. including VAZO 67, which is 2,2′-azobis(2-methylbutane nitrile), VAZO 64, which is 2,2′-azobis(isobutyronitrile), and VAZO 52, which is (2,2′-azobis(2,4-dimethylpentanenitrile), and various peroxides such as benzoyl peroxide, cyclohexane peroxide, lauroyl peroxide, and mixtures thereof.

Suitable photoinitiators include those available under the trade designations OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6-trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl) butanone (OMNIRAD 369), 2-methyl-1-[4-(methylthio)phenyl]-2-morpholinopropan-1-one (OMNIRAD 907), and 2-hydroxy-2-methyl-1-phenyl propan-1-one (OMNIRAD 1173), oligo [2-hydroxy-2-methyl-1-[4-(1-methylvinyl)phenyl]propanone] obtained from IGM Resins under the trade designation ESACURE KIP 150, and difunctional alpha-hydroxy ketones obtained from IGM Resins under the trade designations ESACURE ONE and ESACURE KIP 160 (2-hydroxy-1-[4-[4-(2-hydroxy-2-methylpropionyl) phenoxy]phenyl]-2-methylpropanone). A difunctional alpha-hydroxy ketone means that the photoinitiator includes two alpha-hydroxy ketone groups. A multifunctional alpha-hydroxy ketone means that the photoinitiator includes two or more alpha-hydroxy ketone groups. Additional suitable photoinitiators include benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

Further suitable photoinitiators include mono-ethylenically unsaturated aromatic ketones. Examples of such photoinitiators include multifunctional benzophenones (e.g., acryloxybenzophenone (ABP), para-acryloxyethoxybenzophenone (AEBP), para-N-(methylacryloxyethyl)-carbamoylethoxybenzophenone, 4-acryloyloxydiethoxy~4-chlorobenzophenone) and acetophenones (e.g., para-acryloxyacetophenone and ortho-acrylamidoacetophenone.) Still further suitable photoinitiators include triazines such as 2,4,-bis(trichloromethyl)-6-(4-methoxyphenyl)-triazine, triazines described in U.S. Pat. No. 4,330,590 (Vesley), and 2,4-bis(trichloromethyl)-6-naphthenyl-s-triazine and 2,4-bis(trichloromethyl)-6-(4-methoxy) naphthenyl-s-triazine, described in U.S. Pat. No. 4,329,384 (Vesley)).

In some embodiments of the curable composition of the present disclosure, which may be a capillary suspension, the primary liquid phase further comprises a chain transfer agent, which can be useful, for example, for controlling the molecular weight of a resultant acrylic polymer. Examples of useful chain transfer agents include carbon tetrabromide, alcohols, mercaptans such as isooctylthioglycolate, and mixtures thereof. If used, the primary liquid phase may include up to 0.5 weight of a chain transfer agent based on a total weight of first and optionally second and crosslinking monomers. For example, the primary liquid phase can contain 0.01 to 0.5 weight percent, 0.05 to 0.5 weight percent, or 0.05 to 0.2 weight percent chain transfer agent based on a total weight of first and optionally second and crosslinking monomers.

In some embodiments of the curable composition, which may be a capillary suspension, the primary liquid phase further comprises a polymer prepared from the partial polymerization of the first monomer. In some embodiments, the polymer is prepared from the partial polymerization of the first monomer, one or more second monomers, and/or one or more crosslinking monomers. The curable composition can be a solution of polymer in the first monomer and optionally second and/or crosslinking monomers and can be, for example, about 3 percent to 15 percent polymerized. In some embodiments, the curable composition comprises at least 75, 80, 85, 90, or 95 percent by weight monomer(s), based on the total weight of the curable composition. In some embodiments, the curable composition is exposed to ultraviolet radiation to provide the solution of the polymer in the first monomer. It is also possible for the solution of the polymer in the first monomer to be made by partial free-radical polymerization using a thermal initiator or other free-radical source as described above. Partial polymerization can be carried out by a variety of conventional free radical polymerization methods, including solution, bulk (i.e., with little or no solvent), dispersion, emulsion, and suspension processes. The reaction product of the partial polymerization can be a random or block copolymer.

A useful solvent-free polymerization method is disclosed in U.S. Pat. No. 4,379,201 (Heilmann et al.). Initially, a mixture of first and optionally second and/or crosslinking monomers can be polymerized with a portion of a photoinitiator by exposing the mixture to UV radiation in an inert environment for a time sufficient to form a coatable base syrup, and subsequently adding further second monomer and/or crosslinking monomer and the remainder of the photoinitiator. The monomers can be any of the monomers described above in any of the amounts described above. This final syrup containing a crosslinking agent (e.g., which may have a Brookfield viscosity of about 500 centipoise (cps) to about 10,000 cps at 23° C., about 100 cps to about 6000 cps at 23° C., or about 5,000 cps to about 7,500 cps at 23° C. as measured with a No. 4 LTV spindle, at 60 revolutions per minute) can then be combined with further additives (e.g., optionally tackifying resins and plasticizers, the particles, and the secondary liquid phase as described below.

The primary liquid phase may comprise further components, in particular nonpolar or polar liquids or solvents. The primary liquid phase may include an organic solvent or may be free or essentially free of an organic solvent. As used herein, the term “essentially free” in reference to an organic solvent means that the means that the organic solvent is present in an amount less than 2 weight percent, less than 1 weight percent, less than 0.5 weight percent, less than 0.2 weight percent, or less than 0.1 weight percent based on the weight of the primary liquid phase. Examples of organic solvents include methanol, tetrahydrofuran, ethanol, isopropanol, heptane, acetone, methyl ethyl ketone, methyl acetate, ethyl acetate, toluene, xylene, ethylene glycol alkyl ether, and combinations thereof.

In some embodiments, the curable composition of the present disclosure, which may be a capillary suspension, further comprises a tackifying resin. Tackifying resins and plasticizers (i.e., plasticizing agents) are often added to modulate the Tg, modulate the storage modulus, and/or to alter the tackiness of a pressure-sensitive adhesive. A variety of tackifying resins typically included in conventional pressure-sensitive adhesive compositions may be used. Any tackifying resin that is included in the curable compositions is typically selected to be compatible with the primary liquid phase.

Suitable tackifying resins include rosin resins such as rosin acids and their derivatives (e.g., rosin esters); terpene resins such as polyterpenes (e.g., alpha pinene-based resins, beta pinene-based resins, and limonene-based resins) and aromatic-modified polyterpene resins (e.g., phenol modified polyterpene resins); coumarone-indene resins; and petroleum-based hydrocarbon resins such as C5-based hydrocarbon resins, C9-based hydrocarbon resins, C5/C9-based hydrocarbon resins, dicyclopentadiene-based resins, and combinations thereof. The tackifying resins can be partially or fully hydrogenated if desired. In some embodiments, the tackifying resin comprises at least one of C5-based hydrocarbon resins, C9-based hydrocarbon resins, or C5/C9-based hydrocarbon resins. In some embodiments, the tackifying resin comprises at least one of hydrogenated terpene resins, hydrogenated rosin resins, hydrogenated C5-based hydrocarbon resins, hydrogenated C9-based hydrocarbon resins, or hydrogenated C5/C9-based hydrocarbon resins.

Tackifying resins that are rosin esters are the reaction products of various rosin acids and alcohols. Suitable rosin esters include methyl esters of rosin acids, triethylene glycol esters of rosin acids, glycerol esters of rosin acids, and pentaertythritol esters of rosin acids. The rosin acid and rosin ester tackifying resins are commercially available, for example, from Eastman Chemical Company under the trade designations PERMALYN, STAYBELITE, and FORAL as well as from Newport Industries under the trade designations NUROZ and NUTAC. A fully hydrogenated rosin resin is commercially available, for example, from Eastman Chemical Company under the trade designation FORAL AX-E. A partially hydrogenated rosin resin is commercially available, for example, from Eastman Chemical Company under the trade designation STAYBELITE-E.

Tackifying resins that are hydrocarbon resins can be prepared from various petroleum-based feed stocks. These feed stocks can be aliphatic hydrocarbons (mainly C5 monomers with some other monomers present such as a mixture of trans-1,3-pentadiene, cis-1,3-pentadiene, 2-methyl-2-butene, dicyclopentadiene, cyclopentadiene, and cyclopentene), aromatic hydrocarbons (mainly C9 monomers with some other monomers present such as a mixture of vinyl toluenes, dicyclopentadiene, indene, methylstyrene, styrene, and methylindenes), or mixtures thereof. Tackifying resins derived from C5 monomers are referred to as C5-based hydrocarbon resins while those derived from C9 monomers are referred to as C9-based hydrocarbon resins. Some tackifying resins are derived from a mixture of C5 and C9 monomers or are a blend of C5-based hydrocarbon resins and C9-based hydrocarbon resins. These tackifying resins can be referred to as C5/C9-based hydrocarbon tackifying resins.

The C5-based hydrocarbon resins are commercially available from Eastman Chemical Company under the trade designations PICCOTAC and EASTOTAC, from Cray Valley under the trade designation WINGTACK, from Neville Chemical Company under the trade designation NEVTAC LX, and from Kolon Industries, Inc., under the trade designation HIKOREZ. The C5-based hydrocarbon resins are commercially available from Eastman Chemical with various degrees of hydrogenation under the trade designation EASTOTAC.

The C9-based hydrocarbon resins are commercially available from Eastman Chemical Company under the trade designation PICCO, KRISTLEX, PLASTOLYN, and PICCOTAC, and ENDEX, from Cray Valley under the trade designations NORSOLENE, from Ruetgers N.V. under the trade designation NOVAREZ, and from Kolon Industries, Inc., under the trade designation HIKOTAC. These resins can be partially or fully hydrogenated. Prior to hydrogenation, the C9-based hydrocarbon resins are often about 40 percent aromatic as measured by proton Nuclear Magnetic Resonance spectroscopy. Hydrogenated C9-based hydrocarbon resins are commercially available, for example, from Eastman Chemical under the trade designations REGALITE and REGALREZ that are 50 to 100 percent (e.g., 50 percent, 70 percent, 90 percent, and 100 percent) hydrogenated. The partially hydrogenated resins typically have some aromatic rings.

Various C5/C9-based hydrocarbon tackifying resins are commercially available from Arakawa under the trade designation ARKON, from Zeon under the trade designation QUINTONE, from Exxon Mobile Chemical under the trade designation ESCOREZ, and from Newport Industries under the trade designations NURES and H-REZ (Newport Industries).

Any of the tackifying resins may be used in amounts of up to 100 parts relative to 100 parts of the first monomer and optionally second and further monomers in the primary liquid phase. In some embodiments, the tackifying resin can be used in amounts up to 50 parts, up to 45 parts, up to 40 parts, up to 35 parts, or up to 30 parts relative to 100 parts of the first and optionally second and further monomers. The amount of tackifier can be, for example, in the range of 3 to 50 parts, in the range of 3.5 to 45 parts, in the range of 4 to 40 parts, in the range of 4.5 to 35 parts, from 5 to 30 parts, or in the range of 8 to 25 parts based on 100 parts of the first and optionally second and further monomers.

In some embodiments, the curable composition of the present disclosure, which may be a capillary suspension, further comprises one or more plasticizers. The plasticizer is typically selected to be compatible with (i.e., miscible with) the primary liquid phase. Examples of suitable plasticizers include various polyalkylene oxides (e.g., polyethylene oxides or propylene oxides), adipic acid esters, formic acid esters, phosphoric acid esters, benzoic acid esters, phthalic acid esters, sulfonamides, naphthenic oils, and combinations thereof.

The secondary liquid phase in the curable composition of the present disclosure, which may be a capillary suspension, may generally be any liquid phase that forms two phases with the primary liquid phase at 30° C. and below. Examples of suitable secondary liquid phases include water, aqueous acids (e.g., hydrochloric acid), alkyl alcohols (e.g., alkyl alcohols with 1 to 4 carbon atoms), polyols, glycerine, carbonate-based solvents (e.g., propylene carbonate), sulfoxides (e.g., dimethyl sulfoxide), sulfones (e.g., sulfolane), cyrene, polar polymerizable liquids (e.g., acrylic acid and methacrylic acid), ionic liquids (e.g., 2-hydroxyethylammonium formate, choline acetate, 1-benzyl-3-methylimdiazolium 1,1,2,2-tetrafluoroethanesulfonate, 1-methyl-3-tetradecylimidazolium chloride, 1-ethyl-3-methylimidazolium acetate, trihexyltetradecylphosphonium chloride), polymerizable ionic liquids (e.g., 1-allyl-3-methylimidazolium bis(trifluoromethylsulfonyl)imide, 1-butyl-3-vinylimidazolium bis(trifluoromethylsulfonyl)imide, 1-ethyl-3-vinylimidazolium bis(trifluoromethylsulfonyl)imide, 1-allyl-3-methylimidazolium chloride, 1-vinyl-3-butylimidazolium chloride, N,N,N,N-butyldimethylmethacryloyloxyethylammonium bis(trifluoromethanesulfonyl)imide), deep eutectic mixtures (e.g., choline chloride/urea such as choline chloride:urea 1:2, choline chloride:malonic acid 1:1, zinc chloride:acetamide 1:3, choline chloride/glycerol such as choline chloride:glycerol 1:2, choline chloride lactic acid 1:2, proline:oxalic acid 3:1, choline chloride/ethylene glycol such as choline chloride:ethylene glycol 1:2), polymerizable deep eutectic mixtures (e.g., choline/acrylic acid such as choline chloride:acrylic acid 1:2, 1:4, and 1:6, tetramethylammonium chloride:acrylic acid 1:2, choline chloride:methacrylic acid 1:2, ethylammonium chloride:acrylic acid 1:1.5), wherein the ratios provided above for eutectic mixtures are molar ratios, liquids containing dissolved salts (e.g., [2-(acryloyloxy)ethyl]trimethylammonium chloride solution in water, [2-(methacryloyloxy)ethyl]trimethylammonium chloride solution in water, and copper sulfate, copper acetate, or potassium permanganate in water or organic solvent), non-polar polymerizable liquids (e.g., perfluoropolyether-urethane acrylates commercially available under the trade designation FLUOROLINK MD 700 and FLUOROLINK AD 1700 from Solvay, Brussels, Belgium, 1,1,1,3,3,3-hexafluoroisopropylmethacrylate, 2,2,3,3,4,4,5,5-octafluoropentylmethacrylate, tridecafluorohexylethyl methacrylate, 1H, 1H,2H,2H-perfluorooctyl acrylate), non-polar liquids (e.g., hydrofluoroethers such as those described in U.S. Pat. No. 9,803,110 (Lee et al.) and those commercially available under the trade designations NOVEC 7100 Engineered Fluid, NOVEC 7200 Engineered Fluid, NOVEC 7300 Engineered Fluid, and NOVEC 7500 Engineered Fluid from 3M Company, St. Paul, MN, perfluorinated liquids such as those commercially available under the trade designations FLUORINERT Electronic Liquid FC-3283 and FLUORINERT Electronic Liquid FC-72 from 3M Company), oils (e.g., silicone oils, organic oils, vegetable oils, mineral oils such as paraffin oil and petroleum, and naphthenic oil, and combinations thereof. In some embodiments, the secondary liquid comprises water. In some embodiments, the secondary liquid comprises at least one of water or a polymerizable compound (e.g., a polar polymerizable liquid or a non-polar polymerizable liquid). In some embodiments, the secondary liquid comprises at least one of water or an oil.

Further examples of suitable ionic liquids include salts derived from 1-methylimidazole, i.e., 1-alkyl-3-methylimidazolium salts. Examples of suitable imidazolium cations include 1-ethyl-3-methylimidazolium salts (EMIM), 1-butyl-3-methylimidazolium salts (BMIM), 1-octyl-3 methylimidazolium salts (OMIM), 1-decyl-3-methylimidazolium salts (DMIM), 1-dodecyl-3-methylimidazolium salts (docecylMIM), 1-butyl-2,3-dimethylimidazolium (DBMIM), 1,3-di(N,N-dimethylaminoethyl)-2-methylimidazolium (DAMI), and 1-butyl-2,3-dimethylimidazolium (BMMIM). Examples of suitable anions in ionic liquids include chloride, fluoride, tetrafluoroborate (BF₄⁻), hexafluorophosphate (PF₆⁻), bis-trifluoromethanesulfonimide (NTf₂⁻), trifluoromethanesulfonate (OTf), dicyanamide (N(CN)₂⁻), hydrogen sulphate (HSO₄⁻), ethyl sulphate (EtOSO₃⁻). Further examples of suitable ionic liquids include trioctylmethylammonium bis(trifluoromethylsulfonyl)imide, 1-butyl-3-methylimidazolium chloride, and 1-butyl-3-methylimidazolium hexafluorophosphate.

The secondary liquid phase may further comprise nonpolar or polar liquids or solvents provided that the primary and secondary liquid phases form separate phases. Examples of suitable liquids or solvents include alkanes, cycloalkanes, alkenes, alkynes, aromatics, halogenated organic solvents, ketones, amines, amide, ethers, acids, bases, esters, sulfoxides, sulfones, fats, oils, and combinations thereof, provided that the first and second liquid phase form separate phases.

In the curable composition of the present disclosure, which may be a capillary suspension, the particles are insoluble in the primary liquid phase and in the secondary liquid phase at a temperature of 30° C. and below. Thus, at temperatures above 30° C., the particles may be soluble or insoluble in the primary liquid phase and in the secondary liquid phase, but, in some embodiments, they are insoluble. At temperatures below the melting point of the primary liquid phase, the primary phase is in the solid state and forms a heterogeneous mixture with the particles. At temperatures below the melting point of the secondary liquid phase, the secondary phase is in the solid state and forms a heterogeneous mixture with the particles. Insolubility of the particles in the primary liquid phase and in the secondary liquid phase can be determined visually, for example, by combining the particles with the primary liquid phase and secondary liquid phase separately and observing whether they dissolve.

In the curable composition of the present disclosure, which may be a capillary suspension, the primary liquid phase and the secondary liquid phase form separate phases upon mixing at a temperature of 30° C. and below. Thus, at temperatures above 30° C., the primary liquid phase and the secondary liquid phase may form separate phases upon mixing or may form a homogeneous phase. At temperatures below the melting point of both the primary liquid phase and the second liquid phase, both phases are in the solid state and form a heterogeneous mixture. In some embodiments, the primary liquid phase is insoluble in the secondary liquid phase at a temperature of 30° C. and below, and the secondary liquid phase is insoluble in the primary liquid phase at a temperature of 30° C. and below. At temperatures above 30° C., the primary liquid phase may be soluble or insoluble in the secondary liquid phase, but, in some embodiments, is insoluble, and the secondary liquid phase may be soluble or insoluble in the primary liquid phase, but, in some embodiments, is insoluble. At temperatures below the melting point of the primary liquid phase, the primary phase is in the solid state and forms a heterogeneous mixture with the secondary phase. At temperatures below the melting point of the secondary liquid phase, the secondary phase is in the solid state and forms a heterogeneous mixture with the primary phase. Whether the primary liquid phase and in the secondary liquid phase form separate phases can be determined visually, for example, by combining the primary liquid phase and secondary liquid phase together and observing whether they form two separate phases.

In some embodiments, the primary liquid phase is nonpolar and the secondary liquid phase is polar. In some embodiments, the primary liquid phase is nonpolar and the secondary liquid phase is nonpolar.

In some embodiments, the curable composition of the present disclosure, which may be a capillary suspension, comprises a (further) filler material. The further filler material may be dispersed, for example, in the primary liquid phase. Any filler material commonly known to those skilled in the art may be used in the context of the present disclosure. Examples of suitable filler material that can be used include zeolites, clay fillers, glass beads, silica type fillers, hydrophobic silica type fillers, hydrophilic silica type fillers, fumed silica, fibers, in particular glass fibers, carbon fibers, graphite fibers, silica fibers, ceramic fibers, electrically and/or thermally conducting particles, nanoparticles, in particular silica nanoparticles, and combinations thereof. Other additives may optionally be included in the curable composition to achieve any desired properties. Examples of such additives include pigments, toughening agents, reinforcing agents, fire retardants, antioxidants, and various stabilizers. The additives are added in amounts sufficient to obtain the desired end properties. In some embodiments, fillers may be present in the curable composition or in the primary liquid phase in an amount of up to 10, 7.5, 5, or 2.5 wt. %, based on the total weight of the curable composition.

While, in some embodiments, fumed silica is present in the curable composition, fumed silica and other rheology modifiers are not required to achieve the desired flow properties of the curable composition. As shown in the Examples below, curable composition including the primary liquid phase, secondary liquid phase, and particles can behave as capillary suspensions even if they do not contain fumed silica and other rheology modifiers.

The curable composition can be made by combining the primary liquid phase, the secondary liquid phase, and the particles in any order using any standard mixing equipment. A process for making the curable composition can include combining the particles with a previously combined mixture of the primary liquid phase and the secondary liquid phase. Alternatively, a process for making the curable composition can include combining the secondary liquid phase with a previously combined mixture of the primary liquid phase and the particles.

The curable compositions described herein are liquid/liquid/solid multiphasic suspensions. The addition of small amounts of a secondary liquid phase (which is insoluble in a primary liquid phase) to a suspension of particles in the primary liquid phase can lead to particle bridging and network formation through attractive capillary forces. The rheological properties of the are liquid/liquid/solid multiphasic suspensions are significantly altered compared to a two-component solid/liquid suspension by an increase in viscosity, e.g., from a fluid-like to a gel-like state or from a weak to a strong gel. In some embodiments, the liquid/liquid/solid multiphasic suspensions are capillary suspensions. The transfer from a two-component solid/liquid suspension to a capillary suspension and the formation of an internal network happens when the secondary liquid phase either wets the particles much better than the primary liquid phase (pendular state), or when the secondary liquid phase wets the particles much worse than the primary liquid phase (secondary state). In the article “Capillary suspension: Particle networks formed through capillary force” (E. Koos, Current Opinion in Colloids & Interface Science, 19 (2014) 575-584), capillary suspension, their chemistry, formation and properties are discussed.

The network structure of the liquid/liquid/solid multiphasic suspensions can be influenced by volume fractions of particles and secondary liquid phase. Apart from the increased viscosity, other rheological properties, like an induced or increased yield stress, are observed for liquid/liquid/solid multiphasic suspensions believed to be due to capillary forces induced by the added secondary liquid phase leading to a percolating particle network by bridging the particles. As described in the Examples, below, in the linear viscoelastic (LVE) region, the applied strain does not destroy the microstructure of the capillary suspension. The storage modulus G′ is stable on a certain plateau. The larger G′ in the LVE region, the stiffer is the sample. The larger the LVE region, the more stable is the microstructure against shear. When the yield point is reached, G′ decreases. The existence of a capillary suspension was determined by the existence of a flow point detectable through a cross-over of G′ and G″ (elastic modulus) at a certain shear stress TO after the LVE region. At τ below τ0 the composition behaves dominantly elastic (G′>G″) due to the superstructure in the system build through the capillary suspension. At τ higher than τ0 the composition behaves dominantly viscous (G″>G′) as the superstructure is broken down through the forces applied during the measurement.

The curable composition of the present disclosure, which may be a capillary suspension, may be curable by UV treatment, thermal treatment, chemical treatment, visible light treatment, electron beam treatment, reactive gas treatment or pH change treatment. In some embodiments, the curable composition is UV curable.

The present disclosure provides a process for making a pressure-sensitive adhesive (PSA). PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m². PSAs do not embrace compositions merely because they are sticky or adhere to a surface.

The process for making a pressure-sensitive adhesive includes curing the curable composition to make the pressure-sensitive adhesive. In some embodiments, curing comprises exposing the curable composition to radiation. In some embodiment, the curable composition is applied to a substrate and then cured, in some embodiments, with actinic radiation (e.g., visible or UV light), y (gamma) radiation, e-beam radiation, or by thermal curing. In some embodiments, the curable composition is cured with UV radiation.

Once the curable composition is applied to the substrate, polymerization and crosslinking, which may be in addition to polymerization described above for partial polymerization, can be carried out in an inert environment (e.g., nitrogen, carbon dioxide, helium, and argon, which exclude oxygen). A sufficiently inert atmosphere can be achieved by covering the curable composition with a liner (e.g., a release liner), such as silicone-treated PET film. For UV curing, it is desirable that the liner be transparent to UV radiation. In some embodiments, the curable composition can be cured without a liner. Certain commercially available products such as adhesives obtained under the trade designation “3M SCREEN PRINTABLE UV-CURING ADHESIVE SP7202” and “3M SCREEN PRINTABLE UV-CURING ADHESIVE 7555”, from 3M Company, St. Paul, MN, can be cured without a liner and can be useful as the primary liquid phase.

In some embodiments, the process for making a pressure-sensitive adhesive according to the present disclosure further comprises covering the curable composition with a liner before curing the curable composition, wherein the curable composition maintains its thickness for a time period longer or under a greater force than a comparative composition, wherein the comparative composition is the same as the curable composition except that the comparative composition includes no secondary liquid phase.

For UV curing, depending on the photoinitiator used, the curable composition can be exposed to radiation at any desired wavelength, for example, any wavelength or wavelengths in a range from 320 nm to about 350 nm, about 350 nm to about 390 nm, about 350 nm to about 380 nm, or from 320 nm to 420 nm. Any suitable light source may be used, including fluorescent UV bulbs, mercury lamp (e.g., a low-pressure mercury lamp, a medium-pressure mercury lamp, a high-pressure mercury lamp, an ultrahigh-pressure mercury lamp), a xenon lamp, a metal halide lamp, an electrodeless lamp, an incandescent lamp, LEDs, and lasers. The amount of UV irradiation is typically from approximately 1,000 mJ/cm² to approximately 5,000 mJ/cm². An amount of UV irradiation in a range from approximately 1,000 mJ/cm² to approximately 3,000 mJ/cm² can also be useful. For broadband light sources (e.g., a fluorescent UV bulb, mercury lamp, or incandescent lamp), filters may be useful for narrowing the wavelength ranges and/or to modify the intensity of the light source.

When hollow microspheres are used as the particles, the pressure-sensitive adhesive can have a density from 0.45 g/cm³ to 1.5 g/cm³, from 0.45 g/cm³ to 1.10 g/cm³, from 0.50 g/cm³ to 0.95 g/cm³, from 0.60 g/cm³ to 0.95 g/cm³, or from 0.70 g/cm³ to 0.95 g/cm³.

Volatile organic compounds (VOC) reduction regulations are becoming increasingly common in a variety of field (e.g., in the construction market or in the automotive or electronics industries). Known acrylate-based pressure-sensitive adhesives can contain low molecular weight organic residuals, such as organic solvents and un-reacted monomers arising from the polymerization process, polymerization initiator residuals, contaminations from raw materials, or degradation products formed during the manufacturing process. Using solventless polymerization processes such as those described above and using clean monomers, low VOC tackifying resins, and relatively high-molecular weight photoinitiators (e.g., oligo [2-hydroxy-2-methyl-1-[4-(1-methylvinyl)phenyl]propanone] obtained from IGM Resins under the trade designation ESACURE KIP 150), can be useful for lowering the VOC in the pressure-sensitive adhesives prepared as described herein. The use of specific scavengers for organic contaminants, as described in WO 01/44400 (Yang), is another alternative way to achieve reduced VOC levels.

In some embodiments, the process for making a pressure-sensitive adhesive further comprises dispensing a bead of the curable composition onto a substrate. Liquid compositions and even highly filled compositions not having two liquid phases can flow readily after dispensing and during curing, with the consequence that the shape of the dispensed bead would be lost. The curable compositions of the present disclosure have little to no flow after dispensing, which is beneficial for forming a bond line and 3D printing with the curable composition.

Advantageously, standard automated dispensing and 3D-printing machines can be used to dispense the curable composition of the present disclosure. Such machines are manufactured in a wide range of specifications by different manufacturers like Atlas Copco IAS GmbH, Bretten, Germany; bdtronic GmbH, Weikersheim, Germany; Duerr A G, Stuttgart, Germany; Nordson Corporation, Westlake, Ohio, USA; ViscoTec Pumpen-u. Dosiertechnik GmbH, Töging am Inn, Germany, and by axiss Achsen-und Dosiersysteme GmbH, Keltern-Dietlingen, Germany, for example, under the trade designation “DISPENSEMOVE 700” machine. The curable composition can be dispensed on any of these or similar machines.

Compositions of the present disclosure can advantageously be used in extrusion-based layered deposition systems to make three-dimensional articles. Three-dimensional articles can be made, for example, from computer-aided design (CAD) models in a layer-by-layer manner by extruding the composition. Movement of the extrusion head with respect to the substrate onto which the substrate is extruded is performed under computer control, in accordance with build data that represents the three-dimensional article. The build data is obtained by initially slicing the CAD model of the three-dimensional article into multiple horizontally sliced layers. Then, for each sliced layer, the host computer generates a build path for depositing roads of the composition to form the three-dimensional article.

The composition can be extruded through, for example, a nozzle carried by an extrusion head and deposited as a sequence of roads of molten material on a substrate in an x-y plane. The roads can be in the form of continuous beads or in the form of a series of droplets (e.g., as described in U.S. Pat. Appl. No. 2013/0071599 (Kraibühler et al.)). This can provide at least a portion of the first layer of the three-dimensional article. The position of the nozzle relative to the first layer is then incremented along a z-axis (perpendicular to the x-y plane), and the process is repeated to form at least a second layer of the composition on at least a portion of the first layer. Changing the position of the nozzle relative to the deposited layers may be carried out, for example, by lowering the substrate onto which the layers are deposited. The process can be repeated as many times as necessary to form a three-dimensional article resembling the CAD model. Further details can be found, for example, Turner, B. N. et al., “A review of melt extrusion additive manufacturing processes: I. process design and modeling”; Rapid Prototyping Journal 20/3 (2014) 192-204.

In some embodiments, a (e.g., non-transitory) machine-readable medium is employed in the method of making a three-dimensional article of the present disclosure. Data is typically stored on the machine-readable medium. The data represents a three-dimensional model of an article, which can be accessed by at least one computer processor interfacing with additive manufacturing equipment (e.g., a 3D printer, a manufacturing device, etc.). The data is used to cause the additive manufacturing equipment to create the three-dimensional article.

Data representing an article may be generated using computer modeling such as computer aided design (CAD) data. Image data representing the three-dimensional article design can be exported in STL format, or in any other suitable computer processable format, to the additive manufacturing equipment. Scanning methods to scan a three-dimensional object may also be employed to create the data representing the article. An example of a technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer.

In some embodiments, the process of making a pressure-sensitive adhesive of the present disclosure comprises repeatedly dispensing a bead of the curable composition and curing the curable composition. In some embodiments, the process is carried out discontinuously. For example, the curable composition is dispensed and shaped, followed by curing the shaped composition to provide the article. In some embodiments, the curable composition is shaped and cured to provide part of the pressure-sensitive adhesive, followed by repeating these steps to provide the pressure-sensitive adhesive in its final form. In some embodiments, the curable composition is simultaneously cured and shaped.

In some embodiments, the process of making a pressure-sensitive adhesive of the present disclosure comprises retrieving, from a (e.g., non-transitory) machine-readable medium, data representing a three-dimensional model of a desired three-dimensional article. The process further includes executing, by one or more processors, an additive manufacturing (3D printing) application interfacing with a manufacturing device using the data, and generating, by the manufacturing device, a physical object of the three-dimensional article. While it is in general possible to make the three-dimensional article with support structures, in some embodiments, it is not necessary when using the curable composition of the present disclosure.

A disadvantage of hot melt extrusion, which is a standard method of fused filament fabrication, and other melt extrusion additive manufacturing processes, is the need for significantly elevated temperatures in order to melt the respective polymeric materials used for creation of the three-dimensional form. Also, to retain a shape as close as possible to the desired printing result, measures must be taken that allow for a rapid cooling of the printed product in order to avoid distortions during the cooling process caused by insufficiently cooled, and thus still flowable material. This either limits the choice of possible material or necessitates a tight control of the cooling process. Since the curable composition of the present disclosure is able to hold its shape after dispensing, the process of the present disclosure can obviate these disadvantages.

The curable composition of the present disclosure can also be useful, for example, in vat polymerization 3D printing methods such as stereolithography (SLA), digital light processing (DLP), and liquid crystal display (LCD). For SLA 3D printing, a build platform can be position in a tank of the curable composition. A UV laser can be useful for creating a layer by selectively curing the curable composition according to a desired pattern. Top-down printers place the laser source above the tank, and the build platform moves downwards after each layer is cured. Bottom-up printers place the light source under the resin tank. The tank has a transparent bottom that allows the light of the laser to pass through. While it is in general possible to make the three-dimensional article with support structures, in some embodiments, it is not necessary when using the curable composition of the present disclosure.

The process of the present disclosure does not require the dispensing of multiple layers of the curable composition. In some embodiments, a single layer of the curable composition is dispensed. Shaping of the curable composition can also be carried out in other ways, for example, casting, 3D printing, molding, extrusion, coating, and making a film. The curable composition may be coated on a substrate using any conventional coating techniques modified as appropriate to the particular substrate. For example, the curable composition may be coated on a variety of solid substrates by methods such as roller coating, flow coating, dip coating, spin coating, spray coating knife coating, and die coating. These various methods of coating allow the curable composition to have a variety of thicknesses on the substrate.

The curable composition of the present disclosure can be dispensed or coated upon a variety of substrates to produce adhesive-coated articles. The substrates can be flexible or inflexible and be formed of a polymeric material, glass or ceramic material, metal, or combinations thereof. Suitable polymeric substrates include polymeric films such as those prepared from polypropylene, polyethylene, polyvinyl chloride, polyester (polyethylene terephthalate or polyethylene naphthalate), polycarbonate, polymethyl (meth)acrylate (PMMA), cellulose acetate, cellulose triacetate, and ethyl cellulose. Examples of other substrates include metal such as stainless steel and aluminum, metal or metal oxide coated polymeric material, and metal or metal oxide coated glass. The substrate may be a medium surface energy (MSE) substrate such as polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM) polystyrene, poly(methyl methacrylate) (PMMA), clear coat surfaces, in particular clear coats for vehicles like a car or coated surfaces for industrial applications and composite materials like fiber reinforced plastics.

The pressure-sensitive adhesive made from the curable composition and/or process of the present disclosure may be used in any article conventionally known to use such assemblies such as labels, tapes, signs, covers, marking indices, display components, and touch panels. Flexible backing materials having microreplicated surfaces are also contemplated. The substrate to which the pressure-sensitive adhesive may be applied is selected depending on the particular application. For example, the pressure sensitive adhesive may be applied to sheeting products (e.g., decorative graphics and reflective products), label stock, and tape backings. Additionally, the pressure sensitive adhesive assembly may be applied directly onto other substrates such as a metal panel (e.g., automotive panel) or a glass window so that yet another substrate or object can be attached to the panel or window. Accordingly, the pressure-sensitive adhesive of the present disclosure may find a use in the automotive manufacturing industry (e.g., for attachment of exterior trim parts or for weatherstrips), in the construction industry, and in the solar panel construction industry.

The thickness of the curable composition and the pressure-sensitive adhesive made from the curable composition and/or process of the present disclosure may vary in wide ranges as desired for an intended application. In some embodiments, the thickness of the curable composition and resulting pressure-sensitive adhesive is between 25 μm and 6000 μm, between 40 μm and 3000 μm, between 50 μm and 3000 μm, between 75 μm and 2000 μm, or between 75 μm and 1500 μm. In some embodiments in which the particles comprise hollow microspheres, the thickness is between 100 μm and 6000 μm, between 200 μm and 4000 μm, between 500 μm and 2000 μm, or between 800 μm and 1500 μm.

The curable composition of the present disclosure can be dispensed or coated upon a backing, for example, to make a pressure-sensitive adhesive tape (e.g., a single-sided or double-sided tape. Suitable tape backing layers can be made from plastics (e.g., polypropylene, including biaxially oriented polypropylene, vinyl, polyethylene, polyester such as polyethylene terephthalate), nonwovens (e.g., papers, cloths, nonwoven scrims), metal foils, and foams (e.g., polyacrylic, polyethylene, polyurethane, neoprene). Polymeric foams are commercially available from various suppliers such as 3M Co., Voltek, Sekisui, and others. For a single-sided tape, the pressure-sensitive adhesive is present on one surface of the backing layer, and a suitable release material is applied to the opposite surface of the backing layer. Any suitable release material may be used, including silicones, polyolefins, polycarbamates, and polyacrylics.

When the curable composition is cured on a substrate and/or when the pressure-sensitive adhesive is laminated to the substrate, it may be desirable to treat the surface of the substrate to improve the adhesion. Such treatments are typically selected based on the nature of the materials in the pressure-sensitive adhesive and of the substrate and include primers and surface modifications (e.g., corona treatment and surface abrasion).

In some embodiments, the curable composition of the present disclosure is provided with a release liner on at least one of its major surfaces. As release liner, any suitable material known to the skilled person can be used. For example, a siliconized paper or siliconized polymeric film material, in particular a siliconized PET-film or a siliconized PE or PE/PP blend film material. In some embodiments, the curable composition of the present disclosure can be dispensed or coated on a release liner. The pressure-sensitive adhesive made from the curable composition and/or process of the present disclosure may be provided in the form of a pressure-sensitive adhesive transfer tape in which at least one layer of the pressure-sensitive adhesive is disposed on a release liner for application to a permanent substrate at a later time.

### Some Embodiments of the Present Disclosure

In a first embodiment, the present disclosure provides a curable composition comprising particles in an amount from 25 volume percent to 70 volume percent, based on the total volume of the curable composition; a primary liquid phase in an amount from 25 volume percent to 74.8 volume percent, based on the total volume of the curable composition, the primary liquid phase comprising a first monomer comprising at least one of n-butyl acrylate, an alkyl acrylate monomer, or an alkyl methacrylate monomer, wherein alkyl is linear or branched and has at least five carbon atoms; and a secondary liquid phase in an amount from 0.15 volume percent to 20 volume percent, based on the total volume of the curable composition, wherein the secondary liquid phase and the primary liquid phase form separate phases after mixing within a temperature range of from −20° C. to 30° C., and wherein the particles are insoluble in the primary liquid phase and in the secondary liquid phase within a temperature range of from −20° C. to 30° C. In a second embodiment, the present disclosure provides the curable composition of the first embodiment, which is a capillary suspension. In a third embodiment, the present disclosure provides a pressure-sensitive adhesive precursor capillary suspension. This can also be written as a pressure-sensitive adhesive precursor composition in the form of a capillary suspension and a capillary suspension comprising a pressure-sensitive adhesive precursor composition. In a fourth embodiment, the present disclosure provides the pressure-sensitive adhesive precursor capillary suspension of the third embodiment, comprising particles in an amount from 25 volume percent to 70 volume percent, based on the total volume of the capillary suspension; a primary liquid phase in an amount from 25 volume percent to 74.8 volume percent, based on the total volume of the capillary suspension, the primary liquid phase comprising a first monomer comprising at least one of n-butyl acrylate, an alkyl acrylate monomer, or an alkyl methacrylate monomer, wherein alkyl is linear or branched and has at least five carbon atoms; and a secondary liquid phase in an amount from 0.15 volume percent to 20 volume percent, based on the total volume of the capillary suspension. In a fifth embodiment, the present disclosure provides the curable composition or pressure-sensitive adhesive precursor composition of any one of the first to fourth embodiments, comprising particles in an amount from 35 volume percent to 60 volume percent, based on the total volume of the composition; a primary liquid phase in an amount from 38 volume percent to 64.6 volume percent, based on the total volume of the composition, the primary liquid phase comprising a first monomer comprising at least one of n-butyl acrylate, an alkyl acrylate monomer, or an alkyl methacrylate monomer, wherein alkyl is linear or branched and has at least five carbon atoms; and a secondary liquid phase in an amount from 0.4 volume percent to 3 volume percent, based on the total volume of the composition.

In a sixth embodiment, the present disclosure provides the curable composition or pressure-sensitive adhesive precursor composition of any one of the first to fifth embodiments, wherein the first monomer is present in the primary liquid phase in an amount of at least 50 weight percent, based on the total weight of the primary liquid phase. In a seventh embodiment, the present disclosure provides the curable composition or pressure-sensitive adhesive precursor composition of any one of the first to sixth embodiments, wherein the first monomer comprises at least one of octyl (meth)acrylate, 2-ethylhexyl (meth)acrylate, 2-propylheptyl (meth)acrylate, 2-octyl (meth)acrylate, or n-butyl acrylate. In an eighth embodiment, the present disclosure provides the curable composition or pressure-sensitive adhesive precursor composition of any one of the first to sixth embodiments, wherein the first monomer comprises a mixture of at least two structural isomers of a compound represented by formula:

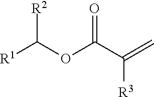

wherein R¹ and R² are each independently a C₁ to C₃₀ saturated linear alkyl group; the sum of the number of carbons in R¹ and R² is 7 to 31; and R³ is H or CH₃. In a ninth embodiment, the present disclosure provides the curable composition or pressure-sensitive adhesive precursor composition of any one of the first to eighth embodiments, wherein the second monomer comprises a polymerizable carbon-carbon double bond and at least one of a polar functional group, a cycloaliphatic group, a heterocyclic group, an aromatic group, or an alkyl group having less than four carbon atoms. Combinations of any of such compounds can be used as the second monomer. In a tenth embodiment, the present disclosure provides the curable composition or pressure-sensitive adhesive precursor composition of any one of the first to ninth embodiments, wherein the second monomer comprises at least one of acrylic acid, methacrylic acid, a hydroxyalkyl acrylate, a hydroxyalkyl methacrylate, isobornyl acrylate, or isobornyl methacrylate. In an eleventh embodiment, the present disclosure provides the curable composition or pressure-sensitive adhesive precursor composition of any one of the first to tenth embodiments, wherein the primary liquid phase further comprises a crosslinking monomer having at least two polymerizable carbon-carbon double bonds, wherein the crosslinking monomer is present in the primary liquid phase in an amount not more than five percent by weight, based on the total weight of the primary liquid phase. In a twelfth embodiment, the present disclosure provides the curable composition or pressure-sensitive adhesive precursor composition of any one of the first to eleventh embodiments, wherein the primary liquid phase further comprises a polymer prepared from the partial polymerization of the first monomer, and optionally the second monomer and/or the crosslinking monomer. In a thirteenth embodiment, the present disclosure provides the curable composition or pressure-sensitive adhesive precursor composition of any one of the first to twelfth embodiments, wherein the primary liquid phase further comprises a free-radical initiator. In a fourteenth embodiment, the present disclosure provides the curable composition or pressure-sensitive adhesive precursor composition of the thirteenth embodiment, wherein the free-radical initiator is a photoinitiator.

In a fifteenth embodiment, the present disclosure provides the curable composition or pressure-sensitive adhesive precursor composition of any one of the first to fourteenth embodiments, wherein the particles comprise at least one of ceramic microspheres, polymeric microspheres, metallic particles, electrically conductive particles, or thermally conductive particles, any of which may be hollow or solid. In a sixteenth embodiment, the present disclosure provides the curable composition or pressure-sensitive adhesive precursor composition of any one of the first to fifteenth embodiments, wherein the particles comprise at least one of hollow ceramic microspheres or hollow polymeric microspheres. In a seventeenth embodiment, the present disclosure provides the curable composition or pressure-sensitive adhesive precursor composition of the sixteenth embodiment, wherein the particles are not electrically conductive or thermally conductive. In an eighteenth embodiment, the present disclosure provides the curable composition or pressure-sensitive adhesive precursor composition of the sixteenth or seventeenth embodiment, wherein the particles are present in an amount from 10 weight percent to 30 weight percent, the primary liquid phase is present in an amount from 65 weight percent to 89.5 weight percent, and the secondary liquid phase is present in an amount from 0.5 weight percent to 5 weight percent, based on the total weight of the curable composition. In a nineteenth embodiment, the present disclosure provides the curable composition or pressure-sensitive adhesive precursor composition of any one of the sixteenth to eighteenth embodiments, wherein the particles comprise hollow ceramic microspheres, and wherein the hollow ceramic microspheres comprise hydrophobic surface groups. In a twentieth embodiment, the present disclosure provides the curable composition or pressure-sensitive adhesive precursor composition of any one of the sixteenth to nineteenth embodiments, wherein the particles comprise hollow glass microspheres. In a twenty-first embodiment, the present disclosure provides the curable composition or pressure-sensitive adhesive precursor composition of any one of the first to twentieth embodiments, further comprising fumed silica.

In a twenty-second embodiment, the present disclosure provides the curable composition or pressure-sensitive adhesive precursor composition of any one of the first to twenty-first embodiments, wherein the secondary liquid phase comprises at least one of water or oil. In a twenty-third embodiment, the present disclosure provides the curable composition or pressure-sensitive adhesive precursor composition of any one of the first to twenty-second embodiments, wherein the secondary liquid phase comprises water. In a twenty-fourth embodiment, the present disclosure provides the curable composition or pressure-sensitive adhesive precursor composition of the twenty-second or twenty-third embodiment, wherein the water further comprises an acid or a salt.

In a twenty-fifth embodiment, the present disclosure provides a pressure-sensitive adhesive made from a capillary suspension. In a twenty-sixth embodiment, the present disclosure provides the pressure-sensitive adhesive of the twenty-fifth embodiment, wherein the capillary suspension is the curable composition or pressure-sensitive adhesive precursor composition of any one of the first to twenty-fourth embodiments. In a twenty-seventh embodiment, the present disclosure provides the pressure-sensitive adhesive of the twenty-fifth or twenty-sixth embodiment, wherein the pressure-sensitive adhesive is made by curing the curable composition or pressure-sensitive adhesive precursor composition of any one of the first to twenty-fourth embodiments. In a twenty-eighth embodiment, the present disclosure provides a process for making a pressure sensitive adhesive, the process comprising curing the curable composition or pressure-sensitive adhesive precursor composition of any one of the first to twenty-fourth embodiments to make the pressure-sensitive adhesive. In a twenty-ninth embodiment, the present disclosure provides the pressure-sensitive adhesive or process of the twenty-seventh or twenty-eighth embodiment, wherein curing comprises exposing the curable composition or pressure-sensitive adhesive precursor composition to radiation. In a thirtieth embodiment, the present disclosure provides the process of the twenty-eighth or twenty-ninth embodiment, further comprising dispensing a bead of the curable composition or pressure-sensitive adhesive precursor composition onto a substrate. In a thirty-first embodiment, the present disclosure provides the process of any one of the twenty-eighth to thirtieth embodiments, covering the curable composition with a liner before curing the curable composition, wherein the curable composition maintains its thickness for a time period longer or under a greater force than a comparative composition, wherein the comparative composition is the same as the curable composition except that the comparative composition includes no secondary liquid phase.

### EXAMPLES

The disclosure is further illustrated by the following examples. These examples are merely for illustrative purposes only and are not meant to be limiting on the scope of the appended claims. Unless otherwise noted, all parts, percentages, ratios, etc. in the Examples are by weight. Unless otherwise indicated, all other reagents were obtained, or are available from fine chemical vendors or may be synthesized by known methods. The following abbreviations are used in this section: hr=hour, min=minute, see=second, g=gram, kg=kilogram, mm=millimeter, centimeter=cm, ° C.=degrees Celsius, N=Newton, Pa=Pascal, mPa=milliPascal, mbar=millibar, rpm=revolutions per minute, W/m·K=watts per meter-Kelvin, J/g/K=Joule per gram per Kelvin, mW/cm²=milliwatts per square centimeter, RH=relative humidity, RT=room temperature, Hz=Hertz, and s=standard deviation.

Table 1 (below) lists materials used in the examples and their sources.

TABLE 1
Materials List

| DESIGNATION | DESCRIPTION |
|---|---|
| Photoinitiator | Bis(2,4,6-trimethylbenzoyl) phenylphosphine oxide, photoinitiator, obtained |
| | under the trade designation “OMNIRAD 819”, from iGM Resins, Waalwijk, |
| | The Netherlands |
| AA | Acrylic acid, from Merck KGaA, Darmstadt, Germany |
| AEROSIL R972 | Hydrophobic fumed silica, obtained under the trade designation “AEROSIL |
| | R972”, from Evonik Industries, Essen, Germany |
| AEROSIL 200 | Hydrophilic fumed silica, obtained under the trade designation “AEROSIL |
| | 200”, from Evonik Industries |
| BAK 10 | Spherical, aluminum oxide particles, Dv50 of about 10 μm, obtained under the |
| | trade designation “BAK 10”, from Bestry Performance Materials, Shanghai, |
| | China |
| BAK 70 | Spherical, aluminum oxide particles, Dv50 of about 70 μm, obtained under the |
| | trade designation “BAK 70”, from Bestry Performance Materials |
| DUALITE | Expanded low-density polymer microspheres, with a diameter of about 40 μm, |
| 135-040D | obtained under the trade designation “DUALITE E135-040D”, from Chase |
| | Corporation-, Westwood, MA |
| 2-EHA | 2-Ethylhexyl acrylate, obtained from BASF, Ludwigshafen am Rhein, |
| | Germany |
| Graphite | Spray can with Graphite, obtained under the trade designation “GRAPHITE |
| | 33”, from CRC Industries Deutschland GmbH, Iffezheim, Germany |
| HCl | Hydrochloric acid with 0.1 mol/L, obtained from Honeywell Specialty |
| | Chemicals Seelze, Seelze, Germany |
| n-Heptane | n-Heptane, solvent, obtained from VWR Chemicals, Radnor, Pennsylvania |
| HPMA | Hydroxypropyl methacrylate, obtained under the trade designation |
| | “VISIOMER HPMA 98, from Evonik Industries |
| HDDA | Hexanediol diacrylate, obtained from 3M Hilden, Hilden, Germany |
| IBOA | Isobornyl acrylate from BASF, Ludwigshafen am Rhein, Germany |
| IOA | Isooctyl acrylate, obtained from 3M Hilden |
| Isopropyl alcohol | Isopropanol, solvent, obtained from VWR Chemicals |
| GB | Hollow glass spheres with a typical density of 0.15 g/cc and with a diameter of |
| | 60 μm, obtained under the trade designation “3M GLASS BUBBLES K15”, |
| | from 3M Company, St. Paul, MN |
| MEK | Methylethylketone, solvent, obtained from VWR Chemicals |
| Oil | Naphthenic process oil, obtained under the trade designation “CALSOL |
| | 5550”, from Calumet, Indianapolis, IN |
| SP7202 | Adhesive, obtained under the trade designation “3M SCREEN PRINTABLE |
| | UV-CURING ADHESIVE SP7202”, from 3M Company |
| SP7555 | Adhesive, obtained under the trade designation “3M SCREEN PRINTABLE |
| | UV-CURING ADHESIVE 7555”, from 3M Company |
| OAIB | Octyl acrylate isomer blend prepared as described in U.S. Pat. No. 9,102,774 |
| | (Clapper et al.) |

### Test Substrates

Stainless Steel (SS) test panels: (“Edelstahl 1.4301 HID”, for Peel Test: 150 mm×50 mm×2 mm; for Static Shear Test: 75 mm×50 mm×2 mm) were obtained from Rocholl GmbH, Eschelbron, Germany. Prior to testing, the substrates were cleaned sequentially with methyl ethyl ketone (MEK), n-heptane, a mixture of isopropyl alcohol and distilled water (1:1), and MEK and dried with a tissue after every step (“3M PANEL WIPES PN345672”, available from 3M Company).

PMMA (Poly methyl methacrylate) test panels: (Röhm “Plexiglas XT 20070FF”, 150 mm×25 mm×2 mm) were obtained from Rocholl GmbH. These test panels were cleaned with a 1:1 mixture of isopropylalcohol and distilled water and rubbed dry with a tissue after cleaning (“3M PANEL WIPES PN345672”, available from 3M Company.

Aluminum test panels: (“5005A (AlMg1)” (50 mm×25 mm×1 mm) were obtained from Rocholl GmbH. These test panels were cleaned with MEK in an ultrasonic bath (RK 103H Sonorex, Bandelin, Berlin, Germany) for 15 min. The overlap area of the shear test panels (12.7 mm×25 mm) was sandblasted with a SMG25 (MHG Sandstrahlanlage, Düsseldorf, Germany). Prior to testing, the tests panels were cleaned again with MEK in the same ultrasonic bath for 15 min. The test panels were rubbed dry with a tissue after cleaning (“3M PANEL WIPES PN345672”, available from 3M Company) and left 10 min to dry.

### Test Methods

### Overlap Shear Test

Overlap shear strength was determined according to ASTM D1002 using a tensile tester of the type ZWICK/ROELL Z005 (available from Zwick GmbH & Co. KG, Ulm, Germany) at a crosshead speed of 12.7 mm/min. For the test assembly preparation, two aluminum test panels as described above, were joined in an overlap connection of 12.7 mm×25 mm width using pressure sensitive adhesive assemblies of the current invention and by pressing these overlap shear test assemblies for 30 sec with 150 N (+/−5N). The test assemblies were then conditioned prior to testing for at least 72 hr at RT at 23° C. (+/−2° C.) and 50% RH (+/−5%). Test results were expressed in N. The quoted shear values were the average of three overlap shear test measurements.

### 90° Peel Adhesion Test

For 90° peel adhesion testing, the procedure according to Test Method AFERA 5001 was followed. A pressure sensitive adhesive film strip with a width of 12.7 mm and a length>175 mm was cut from the sample. For test sample preparation, the liner was first removed from the one adhesive side and placed on an aluminum strip having the following dimensions: 22 cm×1.6 cm. Then, the adhesive coated side of each PSA strip was placed, after the liner was removed, with its adhesive side down on a clean test panel. Next, the test samples were rolled twice in each direction with a standard FINAT test roller (weight 6.8 kg) at a speed of approximately 10 mm per second to obtain intimate contact between the adhesive mass and the surface. After applying the pressure sensitive adhesive strips to the test panel, the test samples were allowed to dwell 20 min or 72 hr at RT (23° C.+/−2° C., 50% RH+/−5%) prior to testing.

For peel testing, the test samples were in a first step clamped in the lower movable jaw of a Zwick tensile tester (Model Z005, available from Zwick/Roell GmbH). The pressure sensitive adhesive strips were folded back at an angle of 90° and their free ends grasped in the upper jaw of the tensile tester in a configuration commonly utilized for 90° peel measurements. The tensile tester was set at 300 mm per minute jaw separation rate. Test results were expressed in Newton per 10 mm (N/10 mm). The quoted peel values were the average of two 90°-peel measurements.

### Static Shear Test

The static shear was a measure of the cohesiveness or internal strength of an adhesive. It was measured in units of time (minutes) required to pull a standard area of adhesive sheet material from a stainless steel test panel described above under stress of a constant, standard load. A pressure sensitive adhesive film strip of 12.7 mm width and 25.4 mm length was cut out from the sample, and the specimen was placed on a clean steel test panel. The opposing side of the test sample was then placed on an aluminum plate having a hole for fixing the weight using light finger pressure. The standard FINAT test roller (weight 6.8 kg) was rolled twice in each direction at a speed of approximately 5 mm per see to obtain intimate contact between the pressure sensitive adhesive mass and the substrate surface (test plate). After applying the pressure sensitive adhesive film strip (specimen) to the test plate, the test plate was allowed a dwell time at RT (23° C.+/−2° C., 50% RH+/−5%) for a period of 24 h before testing.

The test panel was placed in a shear holding device. After a 10-min dwell time at 70° C., the 500 g load was hung into the hole of the aluminum test panels. The timer was started. The results were recorded in minutes until failure and were the average of three measurements unless stated otherwise. A recorded time of “10000+” indicated that the tape did not fail after 10000 minutes, when the test was stopped.

### Rheological Measurement

A rheometer HAAKE MARS 40 (Thermo Fisher Scientific, Waltham, MA) was used to characterize the uncured formulations. A plate-plate geometry was used with a plate diameter of 35.0 mm. The sample was placed between the plates and equilibrated for up to 20 sec until a stable temperature of 20° C. (±0.2° C.) was reached. The test method “oscillating amplitude sweep” was used. The parameters for the measurement were as follows: shear stress τ=0.1 Pa-1000 Pa; frequency f=1 Hz; number of steps=41 (logarithmically distributed); 3 repetitions per step.

In the linear viscoelastic (LVE) region, the applied strain was not destroying the microstructure of the samples. The storage modulus G′ was stable on a certain plateau. The larger G′ in the LVE region, the stiffer the sample was. The larger the LVE region, the more stable was the microstructure against shear. When the yield point was reached, G′ decreased. The shear stress T at the end of LVE region, as well as the average G′ in the LVE region were given in Pa.

The existence of a capillary suspension was determined by the existence of a flow point detectable through a cross-over of G′ and G″ (elastic modulus) at a certain shear stress τ0 after the LVE region. At τ below τ0, the samples behaved dominantly elastic (G′>G″) due to the superstructure in the system build through the capillary suspension. At τ higher than τ0, the samples behaved dominantly viscous (G″>G′) as the superstructure was broken down through the forces applied during the measurement. The shear stress T at G′=G″ was given in Pa.

### Through-Plane Thermal Conductivity (λ) Measurements

The through-plane thermal conductivity (λ) of thermally conductive pressure sensitive adhesive samples was calculated according to equation: λ=a·ρ·cP, whereby thermal conductivity (λ) was expressed in (W/m·K), thermal diffusivity (a) was expressed in (mm²/s), specific heat (cP) was expressed in (J/g/K) and density (ρ) was expressed in (g/cm³). The values of parameters (a) and (cP) were simultaneously determined using Flash Apparatus (Nanoflash LFA 447 available from Netzsch, Selb, Germany) according to Test Method ASTM E 1461/DIN EN 821 using the flash method at 25° C. The test samples had the following dimensions: 10 mm (length)×10 mm (width)×1 mm (thickness) and were sprayed with graphite for higher absorption of the samples. Each side of the samples (n=3) were sprayed with 2 sprays and left for drying for 2 min.

### Examples

### Preparation of Precursors:

In step 1, polymeric precursors were prepared by combining the monomers with photoinitiator in a glass vessel. Before the UV exposure was initiated, the mixture was flushed 10 minutes with nitrogen and nitrogen was also bubbled into the mixture the whole time until the polymerization process was stopped by adding air to the mixture. All the time, the mixture was stirred with a propeller stirrer (300 rpm), and the reaction was stopped when a viscosity between 2000 and 4500 mPa was reached (when measured with a Brookfield viscosimeter, T=23° C., spindle 4, 12 rpm). In step 2, the remaining amount of initiator, the HDDA crosslinker, and optionally, further monomers were added to the composition. These primary liquid phases were homogenized by rolling at 35 rpm for 2 hr on a LABINCO LD209750 Rolling Bench jar roller (available from LABINCO, Breda, Netherlands). The exact amounts of materials used to prepare primary liquid phases is given in Table 2.

TABLE 2
Primary Liquid Phase composition in grams

| | Step 1 | | | | | Step 2 | | | | |
|---|---|---|---|---|---|---|---|---|---|---|
| Name | OAIB | 2-EHA | AA | Initiator | HDDA | AA | HPMA | IBOA | Initiator | HDDA |
| P1 | 90 | | 10 | 0.07 | | | | | 0.33 | 0.12 |
| P2 | 95 | | 5 | 0.07 | | 5 | | | 0.33 | 0.12 |
| P3 | 95 | | 5 | 0.07 | | | 5 | | 0.33 | 0.12 |
| P4 | 95 | | 5 | 0.07 | 0.03 | | 5 | | 0.33 | 0.09 |
| P5 | 95 | | 5 | 0.07 | 0.05 | | 5 | | 0.33 | 0.09 |
| P6 | 96 | | 4 | 0.07 | | | | 10 | 0.33 | 0.12 |
| P7 | | 90 | 5 | 0.07 | | | 5 | | 0.33 | 0.12 |

### Preparation of Comparative Examples (C1-C11)

Composition of the base formulations C1-C11 are reported in Tables 3-6. Each formulation was prepared by combining all components in a polypropylene mixing cup. The cup was closed with a polypropylene lid and the mixture was high shear mixed at ambient temperature and pressure using a SPEEDMIXER (available from Hauschild DAC 400.2 VAC-P, Hamm, Germany) for 30 s at 1600 rpm at 1000 mbar. The final composition was degassed at 800 rpm with 50 mbar for 120 s. Subsequently, the mixture was coated into a film between two transparent silicone-treated release liners (approximately 15 g formulation per film, 1 mm thick) using a knife coater.

A custom-made UV curing station was used to irradiate the coated syrups. The maximum irradiance of the curing station was 0.2 mW/cm² at a wavelength of 360 nm at 100% lamp intensity. Mercury lamps from the top and the bottom were used to irradiate the syrups for 4 minutes at full intensity levels. After 15 seconds, the samples were removed from the UV source and the irradiation was continued when the film was cooled down (minimum 1 minute waiting time).

### Preparation of Examples 1-17 (Ex. 1-Ex. 17)

Composition of the base formulations 1 to 17 are reported in Tables 3-5. Each formulation was prepared by combining all components besides the secondary phase and additives into a polypropylene mixing cup. The cup was closed with a polypropylene lid and the mixture was high shear mixed at ambient temperature and pressure using a SPEEDMIXER (available from Hauschild DAC 400.2 VAC-P) for 30 s at 1600 rpm at 1000 mbar. The secondary phase (water or oil) was added, and the mixture was mixed again for 30 s at 1600 rpm at 1000 mbar. In case additives were used, additives (2 parts AEROSIL 200 or 4 parts AEROSIL R972) were added, and the mixture was mixed again at 1600 rpm for 30 s at 1000 mbar. The final composition was degassed at 800 rpm with 50 mbar for 120 s. Subsequently, the mixture was coated into a film between two transparent silicone-treated release liners (approximately 15 g formulation per film, 1 mm thick) using a knife coater. The films were irradiated as described above for C1-C11.

In Table 3, below, GB was used for the particles. Each Example and Comparative Example was tested for 90° Peel Adhesion, Static Shear, and Overlap Shear according to the test methods above. The failure mode for all 90° Peel Adhesion tests was adhesive with the exception of Ex. 2 on stainless steel, which exhibited cohesive failure. The results are shown in Table 3, below.

TABLE 3
Examples 1-11, C1, and C2. Amounts are stated in g per 100 g of Primary Liquid Phase (PLP).

| | | | | | | Peel on | | | | | | | | |
|---|---|---|---|---|---|---|---|---|---|---|---|---|---|---|
| | | | | g of | | stainless | | Peel on | | Static | | Overlap | | |
| | | g of | Second | second | | steel | | PMMA | | shear | | Shear | | |
| Name | PLP | particles | phase | phase | Additive | (N/cm) | s | (N/cm) | s | (min) | s | (N) | s | Gelation |
| C1 | P1 | 0 | none | 0.0 | none | 20 | 0.7 | nt | | 10000 | 0 | nt | | no |
| C2 | P1 | 8 | none | 0.0 | none | 34 | 1.9 | 11 | 0.28 | 10000 | | nt | | no |
| Ex. 1 | P1 | 8 | water | 1.0 | none | 49 | 1.9 | 10 | 0.38 | 10000 | 0 | 261 | 45.0 | yes |
| Ex. 2 | P1 | 16 | water | 1.0 | none | 41 | 1.0 | 10 | 0.33 | 10000 | 0 | nt | | yes |
| Ex. 3 | P2 | 16 | water | 0.5 | none | 35 | 0.8 | 12 | 1.2 | 10000 | 0 | 135 | 11.9 | no |
| Ex. 4 | P3 | 16 | water | 1.0 | none | 20.1 | 1.71 | 22.01 | | 530 | 265 | 126.3 | 28.1 | no |
| Ex. 5 | P3 | 16 | water | 0.5 | none | 23.7 | 2.1 | 29.03 | | 176 | 92 | 133 | 10.8 | no |
| Ex. 6 | P4 | 16 | water | 0.5 | none | 24 | 2.1 | 24 | 0.1 | 654 | 178 | 132 | 10.0 | no |
| Ex. 7 | P5 | 16 | water | 0.5 | none | 20 | 1.6 | 20 | 1.0 | 1165 | 667 | 160 | 16.6 | no |
| Ex. 8 | P4 | 16 | water | 0.5 | AEROSIL | 14 | 1.5 | 18 | 0.3 | 840 | 13 | 166 | 5.1 | no |
| | | | | | 200 | | | | | | | | | |
| Ex. 9 | P4 | 16 | water | 0.5 | AEROSIL | 21 | 0.2 | 23 | 0.0 | 10000 | 0 | 182 | 6.3 | no |
| | | | | | R972 | | | | | | | | | |
| Ex. 10 | P1 | 16 | HCl | 2.0 | none | 27 | 3.3 | 27 | 3.3 | nt | | nt | | no |
| Ex. 11 | P1 | 16 | Oil | 2.0 | none | 24 | 2.0 | 24 | 2.0 | nt | | nt | | no |

Note:
Gelation was observed by eye within 24 hours. Samples without water can take up water from air and gel over time.

TABLE 4
Examples 12-15 and C3. Amounts are stated in g per 100 g of PLP.

| | | | | | Peel on | | |
|---|---|---|---|---|---|---|---|
| | | | | | stainless | | Thermal |
| | | | Amount | Amount | steel | | conductivity |
| Name | PLP | Particles | Particles | of water | (N/cm) | s | (W/mK) |
| C3 | P8 | BAK 70 + | 400 | 0 | 12 | 0.6 | 1.2 |
| | | BAK 10 (2:1) | | | | | |
| Ex. 12 | P8 | BAK 70 + | 400 | 0.5 | 13 | 1.4 | 1.1 |
| | | BAK 10 (2:1) | | | | | |
| Ex. 13 | P8 | BAK 70 + | 400 | 1 | 13 | 0.5 | 1.2 |
| | | BAK 10 (2:1) | | | | | |
| Ex. 14 | P2 | BAK 70 + | 400 | 1 | 6 | 0.04 | 1.0 |
| | | BAK 10 (2:1) | | | | | |
| Ex. 15 | P3 | BAK 70 + | 400 | 1 | 14 | 2.46 | 1.1 |
| | | BAK 10 (2:1) | | | | | |

TABLE 5
Examples 16 and 17, C4, and C5. Amounts are stated in g per 100 g of PLP.

| | | | | | Peel on | | | | |
|---|---|---|---|---|---|---|---|---|---|
| | | | | | stainless | | | Static | |
| | | | Amount | Amount | steel | | Failure | shear | |
| Name | PLP | Particles | Particles | of water | (N/cm) | s | mode | (min) | s |
| C4 | SP 7555 | | 0 | 0.0 | 4 | 0.8 | adhesive | 28 | 2 |
| C5 | SP 7202 | | 0 | 0.0 | 13 | 0.4 | adhesive | 17 | 9 |
| Ex. 16 | SP 7555 | K15 | 16 | 1.0 | 10 | 0.2 | adhesive | 43 | 3 |
| Ex. 17 | SP 7202 | K15 | 8 | 1.0 | 19 | 0.6 | adhesive | 222 | 63 |

These samples are curable without a liner; however, for ease of preparation of test samples, all tested samples were prepared between two liners.

### Preparation of Examples 18-35 (Ex. 18-Ex. 35)

Composition of the base formulations Ex. 18-35 are reported in Table 6. Each formulation was prepared by combining both liquid phases into a polypropylene mixing cup. The cup was closed with a polypropylene lid and the mixture was high shear mixed at ambient temperature and pressure using a SPEEDMIXER (available from Hauschild DAC 400.2 VAC-P, Hamm Germany) for 30 s at 1600 rpm at 1000 mbar. Directly after the mixing, the filler was added to the suspension and the mixture was mixed for 60 s at 1600 rpm at 1000 mbar. The final composition was degassed at 800 rpm with 50 mbar for 120 s. Subsequently, the mixture was analyzed on the Rheometer (HAAKE MARS 40 available from Thermo Fisher Scientific, Waltham, MA) and coated into a film between two transparent silicone-treated release liners (approximately 15 g formulation per film, 1 mm thick) using a knife coater. The films were irradiated as described above for C1-C11.

TABLE 6
Examples 18-35. Amounts are stated in g per 100 g of PLP.

| | | | | | LVE | End of | Flow | Peel on | |
|---|---|---|---|---|---|---|---|---|---|
| | | | | | plateau | LVE | point | stainless | |
| | | | Particle | Water | value, G′ | region, τ | G′ = G″, τ | steel | |
| Name | PLP | Particles | amount | amount | in Pa | in Pa | in Pa | (N/cm) | s |
| Ex. 18 | P1 | K15 | 16 | 4.0 | 538400 | 85 | 175 | 16 | 0.0 |
| Ex. 19 | P1 | K15 | 16 | 1.0 | 18 | 4 | — | 52 | 4.0 |
| Ex. 20 | P1 | K15 | 8 | 1.0 | 4 | 3 | — | 41 | 0.2 |
| C6 | P1 | K15 | 8 | 0.0 | — | — | — | 34 | 3.3 |
| Ex. 21 | P2 | K15 | 16 | 4.0 | 546700 | 12 | 208 | 12 | 1.1 |
| Ex. 22 | P2 | K15 | 16 | 2.0 | 523000 | 40 | 175 | 30 | 0.2 |
| Ex. 23 | P2 | K15 | 16 | 1.0 | 2705 | 30 | 205 | 40 | 0.0 |
| C7 | P2 | K15 | 16 | 0.0 | 40 | 23 | — | 23 | 3.0 |
| Ex. 24 | P5 | K15 | 16 | 4.0 | 538700 | 62 | 175 | 18 | 4.4 |
| Ex. 25 | P5 | K15 | 16 | 2.0 | 508700 | 63 | 174 | 14 | 3.6 |
| Ex. 26 | P5 | K15 | 16 | 1.0 | — | — | — | 24 | 1.5 |
| C8 | P5 | K15 | 16 | 0.0 | 31 | — | — | 25 | 0.2 |
| Ex. 27 | P6 | K15 | 16 | 4.0 | 741800 | 98 | 278 | 14 | 1.1 |
| Ex. 28 | P6 | K15 | 16 | 1.0 | 1104 | 2 | 2 | 27 | 1.0 |
| Ex. 29 | P6 | K15 | 16 | 0.5 | 31 | 6 | — | 28 | 2.7 |
| C9 | P6 | K15 | 16 | 0.0 | 33 | 5 | — | 22 | 1.1 |
| Ex. 30 | P6 | K15 | 8 | 1.0 | 18 | 5 | — | 18 | 0.2 |
| Ex. 31 | P6 | DUALITE | 16 | 2.0 | 5707 | 2 | 4 | 29 | 0.6 |
| | | 135-040D | | | | | | | |
| Ex. 32 | SP7202 | K15 | 16 | 2.0 | 398200 | 33 | 179 | 14 | 0.8 |
| Ex. 33 | SP7202 | K15 | 16 | 1.0 | 1107 | 2 | — | 15 | 1.5 |
| C10 | SP7202 | K15 | 16 | 0.0 | 1060 | 1 | — | 9 | 0.5 |
| Ex. 34 | SP 7555 | K15 | 16 | 2.0 | 9590 | 33 | 6 | 10 | 2.9 |
| Ex. 35 | SP 7555 | K15 | 16 | 1.0 | 6413 | 2 | 4 | 15 | 0.1 |
| C11 | SP 7555 | K15 | 16 | 0.0 | — | — | 0 | 11 | 0.8 |

If no LVE values or flow point is given, no LVE region or flow point was detected.

The comparative examples, as well as the limit examples, did demonstrate shorter and smaller LVE regions, if they showed LVE regions at all. The more secondary phase and fillers were in the samples, the more the LVE region was increasing. After a certain amount of filler and secondary phase, G′ was larger than G″ in the LVE region and hence they crossed at higher shear. The existence of such a flow point was defined here as capillary suspension.

### Dispensing of Example 4

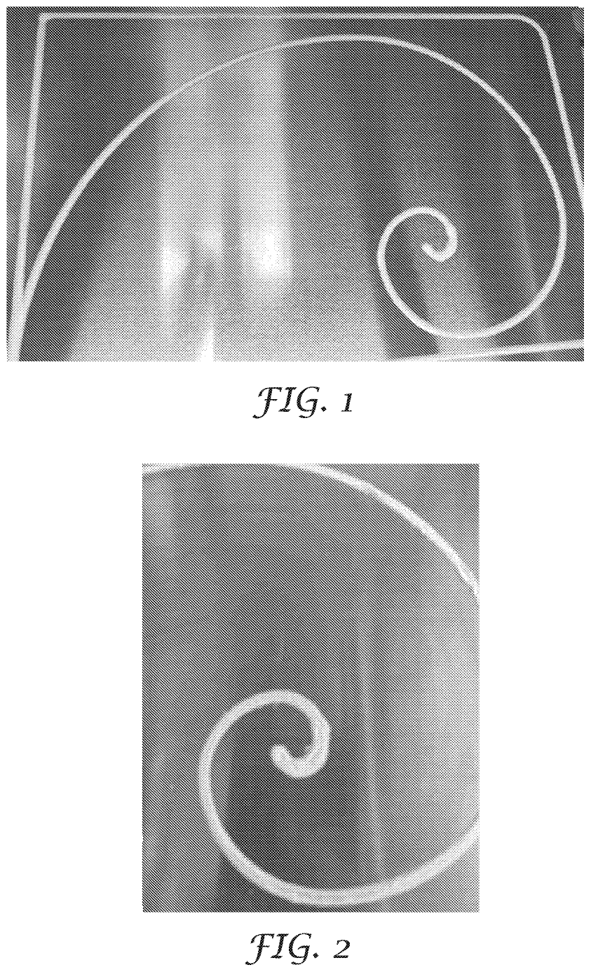

Example 4 was filled in a 310-mL aluminum cartridge type “EURO” (available from Alcan Deutschland GmbH, today Novelis Deutschland GmbH, Goettingen, Germany) right after manufacturing. The cartridge was sealed with the piston and stored for several days at room temperature. Dispensing was carried out on a “Dispensmove 700” machine (available from axiss Achsen-und Dosiersysteme GmbH, Keltern-Dietlingen, Germany). The dispensing took place without heating any elements, so all components including material, equipment and substrate were under constant RT (23° C.). Directly before dispensing, the EURO cartridge tip was opened manually and the standard EURO application nozzle with a round opening with a diameter of 1 mm was mounted. The nozzle was oriented perpendicular to the surface. As a substrate, a sheet of 300 mm×200 mm×2 mm untreated aluminum alloy 5754 AlMg3 (available from Rocholl GmbH, location) was used. Dispensing took place at a distance from nozzle to surface of 1 mm, a nozzle tip speed of 40 mm/s and a volumetric flow rate of 0.1 mL/s. A bead of approximately 1500 mm length was applied on the sheet over an application time of 37 s as shown in FIG. 1. Within 10 min after dispensing, the bead was covered with a transparent liner and cured to tape state by applying UV light with the same equipment and settings as described above for C1-C11. Regular syrup would flow easily in the gap between substrate and liner and thus drastically reduce the height/width ratio of the bead, with the consequence that the intended bead properties would be lost. Example 4 maintained its shape during the curing step as shown in FIG. 2.

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

What is claimed is:

1. A curable composition comprising:
particles in an amount from 25 volume percent to 70 volume percent, based on the total volume of the curable composition;
a primary liquid phase in an amount from 25 volume percent to 74.8 volume percent, based on the total volume of the curable composition, the primary liquid phase comprising a first monomer comprising at least one of n-butyl acrylate, an alkyl acrylate monomer, or an alkyl methacrylate monomer, wherein alkyl is linear or branched and has at least five carbon atoms; and
a secondary liquid phase in an amount from 0.15 volume percent to 20 volume percent, based on the total volume of the curable composition, wherein the secondary liquid phase and the primary liquid phase form separate phases after mixing within a temperature range of from −20° C. to 30° C., and
wherein the particles are insoluble in the primary liquid phase and in the secondary liquid phase within a temperature range of from −20° C. to 30° C.

2. The curable composition of claim 1, wherein the first monomer is present in the primary liquid phase in an amount of at least 50 weight percent, based on the total weight of the primary liquid phase.

3. The curable composition of claim 1, wherein the first monomer comprises a mixture of at least two structural isomers of a compound represented by formula: 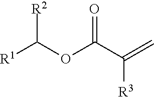
wherein R¹ and R² are each independently a C₁ to C₃₀ saturated linear alkyl group; the sum of the number of carbons in R¹ and R² is 7 to 31; and R³ is H or CH₃.

4. The curable composition of claim 1, wherein the primary liquid phase further comprises at least one second monomer, wherein each second monomer independently comprises a polymerizable carbon-carbon double bond and at least one of a polar functional group, a cycloaliphatic group, a heterocyclic group, an aromatic group, or an alkyl group having less than four carbon atoms.

5. The curable composition of claim 1, wherein the primary liquid phase further comprises a crosslinking monomer having at least two polymerizable carbon-carbon double bonds, wherein the crosslinking monomer is present in the primary liquid phase in an amount not more than five percent by weight, based on the total weight of the primary liquid phase.

6. The curable composition of claim 1, wherein the primary liquid phase further comprises a polymer prepared from the partial polymerization of the first monomer.

7. The curable composition of claim 1, wherein the primary liquid phase further comprises a free-radical initiator.

8. The curable composition of claim 1, wherein the particles comprise at least one of ceramic microspheres, polymeric microspheres, metallic particles, electrically conductive particles, or thermally conductive particles, any of which may be hollow or solid.

9. The curable composition of claim 1, wherein the particles comprise at least one of hollow ceramic microspheres or hollow polymeric microspheres, and wherein the particles are present in an amount from 10 weight percent to 30 weight percent, the primary liquid phase is present in an amount from 65 weight percent to 89.5 weight percent, and the secondary liquid phase is present in an amount from 0.5 weight percent to 5 weight percent, based on the total weight of the curable composition.

10. The curable composition of claim 1, further comprising fumed silica.

11. The curable composition of claim 1, wherein the secondary liquid comprises water.

12. A process for making a pressure-sensitive adhesive, the process comprising:
curing the curable composition of claim 1 to make the pressure-sensitive adhesive.

13. The process of claim 12, further comprising:
dispensing a bead of the curable composition onto a substrate.

14. A capillary suspension comprising a pressure-sensitive adhesive precursor.

15. (canceled)

16. The capillary suspension of claim 14, comprising particles in an amount from 25 volume percent to 70 volume percent, based on the total volume of the capillary suspension; a primary liquid phase in an amount from 25 volume percent to 74.8 volume percent, based on the total volume of the capillary suspension, the primary liquid phase comprising a first monomer comprising at least one of n-butyl acrylate, an alkyl acrylate monomer, or an alkyl methacrylate monomer, wherein alkyl is linear or branched and has at least five carbon atoms; and a secondary liquid phase in an amount from 0.15 volume percent to 20 volume percent, based on the total volume of the capillary suspension.

17. The capillary suspension of claim 16, wherein the first monomer comprises at least one of octyl (meth)acrylate, 2-ethylhexyl (meth)acrylate, 2-propylheptyl (meth)acrylate, 2-octyl (meth)acrylate, or n-butyl acrylate.

18. The capillary suspension of claim 16, wherein the primary liquid phase further comprises at least one second monomer, wherein the second monomer comprises a polymerizable carbon-carbon double bond and at least one of a polar functional group, a cycloaliphatic group, a heterocyclic group, an aromatic group, or an alkyl group having less than four carbon atoms.

19. The capillary suspension of claim 16, wherein the particles comprise at least one of hollow ceramic microspheres or hollow polymeric microspheres, and wherein the particles are present in an amount from 10 weight percent to 30 weight percent, the primary liquid phase is present in an amount from 65 weight percent to 89.5 weight percent, and the secondary liquid phase is present in an amount from 0.5 weight percent to 5 weight percent, based on the total weight of the capillary suspension.

20. The capillary suspension of claim 14, comprising particles in an amount from 35 volume percent to 60 volume percent, based on the total volume of the capillary suspension; a primary liquid phase in an amount from 38 volume percent to 64.6 volume percent, based on the total volume of the capillary suspension, the primary liquid phase comprising a first monomer comprising at least one of n-butyl acrylate, an alkyl acrylate monomer, or an alkyl methacrylate monomer, wherein alkyl is linear or branched and has at least five carbon atoms; and a secondary liquid phase in an amount from 0.4 volume percent to 3 volume percent, based on the total volume of the capillary suspension.

21. The capillary suspension of claim 14, further comprising a photoinitiator.
